(19) United States
(12) Patent Application Publication
(10) Pub. No.: US 2025/0126137 A1
(43) Pub. Date: Apr. 17, 2025

(54) SYSTEM AND METHOD FOR PROVIDING CYBERSECURITY SERVICES IN DUAL-STACK TRAFFIC PROCESSING WITHIN COMMUNICATION NETWORKS

(71) Applicant: Privafy Inc, Burlington, MA (US)

(72) Inventors: Vijay Sankar Veeriah, Bangalore (IN); Srinivasan Krishnamoorthy, Bangalore (IN); Bala Srinivasa Lalith Kumar Sesham, Bangalore (IN); Srinivas Shetti, Bangalore (IN); Rajesh Kumar Sahoo, Bangalore (IN)

(21) Appl. No.: 18/916,915

(22) Filed: Oct. 16, 2024

Related U.S. Application Data
(60) Provisional application No. 63/590,790, filed on Oct. 17, 2023.

(51) Int. Cl. H04L 9/40; H04L 61/251

(52) U.S. Cl. CPC H04L 63/1416; H04L 61/251; H04L 63/1425

(57) ABSTRACT

A system and a method for providing cybersecurity services in dual-stack traffic processing within one or more communication networks are disclosed. The system comprises one or more carrier edge nodes to transmit traffic data packets between one or more communication devices and one or more network services within the one or more communication networks by translating Internet Protocol version 6 (IPv6) addresses to Internet Protocol version 4 (IPv4) addresses. The one or more carrier edge nodes configured to assign one or more virtual local area network (VLAN) tags to at least one of: outbound communication device-originated data, and inbound communication device-originated data for identifying the traffic data packets. The one or more carrier edge nodes segments at least one of: the outbound and the inbound communication device-originated data into one or more categories for dynamically enforcing one or more security policies to provide the cybersecurity services.

### EARLIEST PRIORITY DATE

This application claims priority from a Provisional patent application filed in the United States of America having Patent Application No. 63/590,790, on Oct. 17, 2023, and titled “SYSTEM AND METHOD FOR ROUTING AND PROCESSING DUAL-STACK TRAFFIC IN A COMMUNICATION NETWORK”.

### TECHNICAL FIELD

Embodiments of the present disclosure relate to computer networking, and more particularly relate to a computer-implemented system and a computer-implemented method for providing cybersecurity services in dual-stack traffic processing within one or more communication networks.

### BACKGROUND

In recent years, a transition from Internet Protocol version 4 (IPv4) to Internet Protocol version 6 (IPv6) addressing in mobile networks has become increasingly necessary due to exhaustion of available IPv4 addresses. Mobile operators are gradually moving towards IPv6-only core networks to accommodate a growing number of connected one or more communication devices. However, the transition presents challenges in providing seamless security services, as many internet services and security systems still predominantly operate using the IPV4 addresses.

The transition is driven by scarcity of the available IPv4 addresses. IPv4 uses a 32-bit address space, allowing for a limited number of unique addresses. However, as the number of the connected one or more communication devices continues to rise exponentially, the limited 32-bit address space is rapidly being exhausted.

To overcome the limitations of the IPV4, networking industry has embraced IPV6, which employs a 128-bit address space. The vast 128-bit address space provides an astronomical number of the unique addresses. The adoption of the IPV6 ensures that the growing number of the one or more communication devices are assigned the unique address and maintain connectivity to internet.

Nevertheless, a challenge arises from the fact that many internet services, including websites, applications, and infrastructure, still predominantly operate on the IPV4. The internet services are built around an older addressing system and may not be fully compatible with the IPv6. As a result, the networking industry faces the technical challenge of enabling smooth communication between the one or more communication devices using the IPV6 addresses and the existing IPv4-based internet services.

Existing technology discloses techniques for communicating via IPv6-only networks with the one or more communication devices on the IPV4 networks. This method involves generating a request to access a network server that specifies an IPv4 literal, querying a Domain Name System (DNS) server to determine an IPV6 prefix, synthesizing the IPV6 address using the IPv6prefix and the IPV4 literal, and creating a transport layer connection using the synthesized IPv6 address. While this approach enables the communication between the IPv6 networks and the IPV4 networks, this approach may not specifically address the application of security policies in a mixed Internet Protocol (IP) environment or handle the complexities of processing security-related data that may contain the IPV4 addresses.

In another existing technology, a method to enhance connectivity between an IPv6-only Session Initiation Protocol (SIP) client and an IPV4-only server or client is disclosed. The method assigns the IPV6-only client an IPV4-translatable IPV6 IP address and extracts an IPv4 IP address for use in SIP communications. Although the method facilitates the communication between IPV6 endpoints and IPv4 endpoints in SIP sessions, the method may not provide a comprehensive framework for applying the security services across a diverse range of applications and protocols in an IPV6-only mobile network environment.

Existing solutions face several technical challenges. The existing solutions require complex configurations and additional protocols, increasing the overall complexity of network infrastructure and potentially introducing new points of failure. The use of Network Address Translation (NAT) may introduce latency and impact network performance. Moreover, the existing solutions may not adequately address the specific security requirements of mobile networks, particularly in handling security policies and threat intelligence data that are predominantly based on the IPV4 addresses.

The limitations of current technologies create significant technical problems in communication networking. The coexistence of the IPV4 and the IPV6 introduces compatibility issues, making it difficult to integrate and communicate between IPv6-based networks and legacy IPv4 systems. Network fragmentation occurs due to the use of various mechanisms to bridge the IPv4 networks and the IPV6 networks, thereby resulting in complex routing and suboptimal network performance. Additionally, the existing solutions struggle with scalability and performance issues as the number of the connected one or more communication devices and data-intensive applications continues to grow.

Therefore, there is a need for a system that may effectively provide the security services for one or more users in an IPV6-only core network while seamlessly handling communication with IPv4-based services and security systems. Such a system should address the challenges of applying security policies in a mixed IP environment, efficiently process security-related data containing the IPV4 addresses, and maintain high performance and scalability in the face of increasing network complexity and traffic volume.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computer-implemented system and a computer-implemented method for providing cybersecurity services in dual-stack traffic processing within one or more communication networks are disclosed.

In an embodiment, the computer-implemented system comprises one or more carrier edge nodes. The one or more carrier edge nodes are configured to transmit traffic data packets between one or more communication devices and one or more network services within the one or more communication networks. Each carrier edge node of the one or more carrier edge nodes comprises one or more hardware processors and a memory unit. Each carrier edge node of the one or more carrier edge nodes is further configured to transmit the traffic data packets to Internet Protocol version 4 (IPv4) destinations through the one or more carrier edge nodes while bypassing Internet Protocol version 6 (IPv6) addresses at each carrier edge node of the one or more carrier edge nodes until complete IPV6 security policies are enforced. Each carrier edge node of the one or more carrier edge nodes is further configured to provide customer-side translator (CLAT) functionality for outbound communication device-originated data with only the IPV6 addresses, using a derived network address translation 64 (NAT64) prefix within one or more NAT64 prefixes to synthesize the IPV6 addresses for the IPv4 destinations.

In an aspect, the memory unit is operatively connected to the one or more hardware processors. The memory unit comprises a set of computer-readable instructions in form of a plurality of subsystems, configured to be executed by the one or more hardware processors. The plurality of subsystems comprises a tagging subsystem, a prefix detection subsystem, a traffic segmentation subsystem, a security policy enforcement subsystem, and a virtual private network (VPN) management subsystem.

In yet another aspect, the tagging subsystem is configured to assign one or more virtual local area network (VLAN) tags to at least one of: the outbound communication device-originated data, and inbound communication device-originated data. The one or more VLAN tags are configured to identify the traffic data packets to enforce one or more security rules. The one or more VLAN tags comprise at least one of: a) a first tag configured to identify the outbound communication device-originated data for initial processing at each carrier edge node of the one or more carrier edge nodes, b) a second tag is assigned to the outbound communication device-originated data from each carrier edge node of the one or more carrier edge nodes after one or more security policies are enforced for transmitting to the one or more network services, c) a third tag configured to identify the inbound communication device-originated data directed to the one or more communication devices after the inbound communication device-originated data undergone processing at each carrier edge node of the one or more carrier edge nodes, d) a fourth tag is assigned to the inbound communication device-originated data upon detection of one or more malicious domains at each carrier edge node of the one or more carrier edge nodes for transmitting the traffic data packets to the one or more communication devices from the one or more network services, and e) one or more additional VLAN tags are configured to assign to at least one of: the outbound communication device-originated data, and the inbound communication device-originated data based on one or more predefined parameters.

In another aspect, the prefix detection subsystem is configured to translate the IPv6 addresses associated with the outbound communication device-originated data to IPv4 addresses using the one or more NAT64 prefixes. The prefix detection subsystem is configured to query one or more domain name system (DNS) servers to translate the IPV6 addresses by deriving the associated NAT64 prefix within the one or more NAT64 prefixes for authorized communication with the IPV4 destinations associated with the one or more network services. The prefix detection subsystem is further configured to automatically update the NAT64 prefixes based on real-time queries to the one or more DNS servers, ensuring compatibility with updated the IPV4 destinations.

In yet another aspect, the traffic segmentation subsystem is configured to segment at least one of: the outbound communication device-originated data, and the inbound communication device-originated data into one or more categories based on the one or more predefined parameters. The one or more categories comprise at least one of: domain name system (DNS) traffic data, enterprise traffic data, internet-bound traffic data, and intercepted traffic data. The one or more predefined parameters comprise at least one of: a type of application, one or more user roles, one or more traffic characteristics, destination Internet Protocol (IP) address, security requirements, network conditions, and real-time threat intelligence.

Each carrier edge node of the one or more carrier edge nodes is further configured to route the DNS traffic data through the one or more DNS servers configured with user-defined DNS policies to the one or more communication devices using the translated IPv6 addresses for communication with the one or more DNS servers for communicating with the IPv4 addresses. Each carrier edge node of the one or more carrier edge nodes is further configured to perform reputation checks for both the IPV4 addresses and the IPV6 addresses associated with the DNS traffic data. Each carrier edge node of the one or more carrier edge nodes is configured to process the enterprise traffic data to convert the IPV6 addresses to the IPV4 addresses prior to encryption, for secure communication with the IPv4 addresses associated with the one or more network services. Each carrier edge node of the one or more carrier edge nodes is configured to apply a network address translation (NAT) using Small-Medium Business (SMB)-specific Virtual Internet Protocol (VIPs) addresses and route the enterprise traffic data through one or more secure tunnels according to the user-defined DNS instructions. Each carrier edge node of the one or more carrier edge nodes is configured to decrypt and transmit the enterprise traffic data to the one or more communication devices using a designated VLAN tag within the one or more VLAN tags for managing the segmented at least one of: the outbound communication device-originated data, and the inbound communication device-originated data.

The tagging subsystem is further configured to assign the second tag for outbound internet-bound traffic data within the internet-bound traffic data for external transmission. The tagging subsystem is further configured to assign the fourth tag for inbound internet-bound traffic data within the internet-bound traffic data after decrypted for transmitting the traffic data packets to the one or more communication devices from the one or more network services. The traffic segmentation subsystem is configured with a secure sockets layer (SSL) interception module. The SSL interception module is configured to manage the intercepted traffic data through an IPV6-capable SSL proxy for generating outbound intercepted traffic data after the detection of one or more malicious domains for transmitting to the one or more communication devices.

In another aspect, the security policy enforcement subsystem is configured to dynamically enforce the one or more security policies on the segmented at least one of: the outbound communication device-originated data, and the inbound communication device-originated data based on at least one of: the one or more VLAN tags and the one or more predefined parameters. The security policy enforcement subsystem is configured to detect the one or more malicious domains based on the one or more security policies in the traffic data packets for providing the cybersecurity services in the dual-stack traffic processing within the one or more communication networks. The one or more security policies comprise at least one of: firewall policies, intrusion detection and prevention policies, reputation-based filtering policies, access control policies, data encryption policies, malicious domain detection policies, content filtering policies, application-specific policies, bandwidth management policies, and compliance policies.

In yet another aspect, the VPN management subsystem is configured to encapsulate the IPV4 addresses within the IPV6 addresses for providing a VPN communication over an IPV6-only network environment. The VPN management subsystem is configured to generate one or more VPN tunnels using the IPV6 addresses for transmitting the traffic data packets while communicating with the IPv4 addresses.

In accordance with another embodiment of the present disclosure, the computer-implemented method for providing the cybersecurity services in the dual-stack traffic processing within the one or more communication networks. In the first step, the computer-implemented method includes transmitting, by the one or more carrier edge nodes, the traffic data packets between the one or more communication devices and the one or more network services within the one or more communication networks. In the next step, the computer-implemented method includes assigning, by the one or more hardware processors through the tagging subsystem, the one or more VLAN tags to at least one of: the outbound communication device-originated data, and the inbound communication device-originated data to identify the traffic data packets to enforce the one or more security policies.

In the next step, the computer-implemented method includes translating, by the one or more hardware processors through the prefix detection subsystem, the IPV6 addresses associated with the outbound communication device-originated data to IPv4 addresses using one or more NAT64 prefixes. In the next step, the computer-implemented method includes querying, by the one or more hardware processors through the prefix detection subsystem, the one or more DNS servers to translate the IPV6 addresses by deriving the associated NAT64 prefix within the one or more NAT64 prefixes for authorized communication with the IPV4 destinations associated with the one or more network services.

In the next step, the computer-implemented method includes segmenting, by the one or more hardware processors through the traffic segmentation subsystem, at least one of: the outbound communication device-originated data, and the inbound communication device-originated data into the one or more categories based on the one or more predefined parameters. In the next step, the computer-implemented method includes enforcing, by the one or more hardware processors through the security policy enforcement subsystem, the one or more security policies on the segmented at least one of: the outbound communication device-originated data, and the inbound communication device-originated data based on at least one of: the one or more VLAN tags and the one or more predefined parameters. In the next step, the computer-implemented method includes detecting, by the one or more hardware processors through the security policy enforcement subsystem, the one or more malicious domains based on the one or more security policies in the traffic data packets for providing the cybersecurity services in the dual-stack traffic processing within the one or more communication networks.

A non-transitory computer-readable storage medium storing computer-executable instructions that, when executed by the one or more hardware processors, cause the one or more hardware processors to perform operations for providing the cybersecurity services in the dual-stack traffic processing within the one or more communication networks. The operations comprising: a) transmitting the traffic data packets between the one or more communication devices and the one or more network services within the one or more communication networks, b) assigning the one or more VLAN tags to at least one of: the outbound communication device-originated data, and the inbound communication device-originated data to identify the traffic data packets to enforce the one or more security policies, c) translating the IPV6 addresses associated with the outbound communication device-originated data to the IPV4 addresses using the one or more NAT64 prefixes, d) querying the one or more DNS servers to translate the IPv6 addresses by deriving the associated NAT64 prefix within the one or more NAT64 prefixes for authorized communication with the IPV4 destinations associated with the one or more network services, e) segmenting at least one of: the outbound communication device-originated data, and the inbound communication device-originated data into the one or more categories based on the one or more predefined parameters, f) enforcing the one or more security policies on the segmented at least one of: the outbound communication device-originated data, and the inbound communication device-originated data based on at least one of: the one or more VLAN tags and the one or more predefined parameters, and g) detecting the one or more malicious domains based on the one or more security policies in the traffic data packets for providing the cybersecurity services in the dual-stack traffic processing within the one or more communication networks.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture implementing a computer-implemented system for providing cybersecurity services in dual-stack traffic processing within one or more communication networks, in accordance with an embodiment of the present disclosure;

FIG. 2 illustrates an exemplary block diagram representation of the computer-implemented system as shown in FIG. 1 for providing cybersecurity services in dual-stack traffic processing within the one or more communication networks, in accordance with an embodiment of the present disclosure;

FIG. 3 illustrates an exemplary first process flowchart of the computer-implemented system for the dual-stack traffic processing, in accordance with an embodiment of the present disclosure;

FIG. 4 illustrates an exemplary second process flowchart of the computer-implemented system for pure Internet Protocol version 6 (IPv6) that is not routed through one or more carrier edge nodes, in accordance with an embodiment of the present disclosure;

FIG. 5 illustrates an exemplary flowchart of prefix detection and validation, in accordance with an embodiment of the present disclosure;

FIG. 6 illustrates an exemplary service management block, in accordance with an embodiment of the present disclosure;

FIG. 7A illustrates an exemplary flowchart of IPV6 support in the one or more carrier edge nodes for an AppEdge-based anchoring, in accordance with an embodiment of the present disclosure.

FIG. 7B illustrates an exemplary block diagram of the one or more carrier edge nodes for the AppEdge-based anchoring, in accordance with an embodiment of the present disclosure.

FIG. 7C illustrates an exemplary block diagram of customer-side translator (CLAT) functionality within the one or more carrier edge nodes, in accordance with an embodiment of the present disclosure.

FIG. 8 illustrates an exemplary flowchart of packet flows within one or more communication devices with IPV6 addresses, in accordance with an embodiment of the present disclosure;

FIG. 9 illustrates an exemplary block diagram of the computer-implemented system architecture view, in accordance with an embodiment of the present disclosure;

FIG. 10 illustrates an exemplary flow chart of a computer-implemented method for providing cybersecurity services in dual-stack traffic processing within the one or more communication networks, in accordance with an embodiment of the present disclosure; and

FIG. 11 illustrates an exemplary block diagram representation of one or more server platforms for implementation of the disclosed computer-implemented system, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

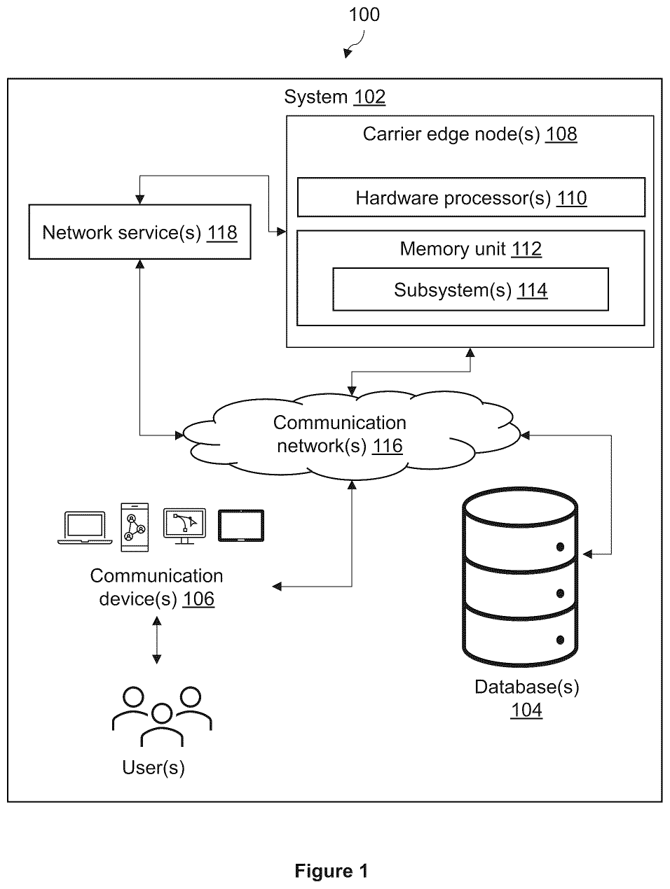

Referring now to the drawings, and more particularly to FIG. 1 through FIG. 11, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 implementing a computer-implemented system 102 for providing cybersecurity services in dual-stack traffic processing within one or more communication networks 116, in accordance with an embodiment of the present disclosure.

According to an exemplary embodiment of the present disclosure, the network architecture 100 may include the computer-implemented system 102, one or more databases 104, one or more communication devices 106, and one or more network services 118. The computer-implemented system 102, the one or more databases 104, the one or more communication devices 106, and the one or more network services 118 may be communicatively coupled via the one or more communication networks 116, ensuring seamless data transmission, processing, and the dual-stack traffic processing. The computer-implemented system 102 acts as the central processing unit within the network architecture 100, responsible for providing cybersecurity services in dual-stack traffic processing within the one or more communication networks 116. The dual-stack traffic processing represents handling both Internet Protocol version 6 (IPv6) addresses and Internet Protocol version 4 (IPv4) addresses simultaneously within the one or more communication networks 116 that is transitioning from the IPV6 addresses to the IPv4 addresses.

In an exemplary embodiment, the computer-implemented system 102 is configured with one or more carrier edge nodes 108. The one or more carrier edge nodes 108 are responsible for processing and routing traffic data packets between the one or more communication devices 106 and the one or more network services 118 within the dual-stack environment that includes both the IPV4 addresses and the IPV6 addresses. Each carrier edge node 108 of the one or more carrier edge nodes 108 comprises one or more hardware processors 110 and a memory unit 112 that includes a set of computer-readable instructions executable by the one or more hardware processors 110 to implement various cybersecurity and traffic management protocols. The traffic management protocols are configured to handle and secure the traffic data packets in an IPV6-only core network while maintaining compatibility with legacy IPv4 network services associated with the one or more network services 118.

Each carrier edge node 108 of the one or more carrier edge nodes 108 may be deployed as an intermediary layer between the one or more communication devices 106 and the one or more network services 118 within the one or more communication networks 116. In this deployment, each carrier edge node 108 serves as a secure and intelligent processing point that manages and routes the traffic data packets between the one or more communication devices 106 and the one or more network services 118 while applying security policies, translating Internet Protocol (IP) addresses, and segmenting traffic based on predefined criteria. Each carrier edge node 108 configured as both a gateway and a security checkpoint by monitoring all network traffic that flows between the one or more communication devices 106 and the one or more network services 118, providing a centralized point for network traffic management, security enforcement, and protocol translation.

The one or more carrier edge nodes 108 may be implemented as one of a: server a network appliance, and a virtualized instance running on a general-purpose server that operates as the central component within the one or more communication networks 116. Each deployment option provides a high degree of flexibility based on network scale, performance requirements, and existing infrastructure. As a hardware apparatus, the one or more carrier edge nodes 108 comprises specialized hardware components, including multiple processors, network interface cards, and hardware acceleration for encryption and processing the traffic data packets. These elements allow it to handle large volumes of traffic with low latency, which is critical in high-performance communication network environments.

The one or more hardware processors 110 may comprise a combination of discrete components, an integrated circuit, an application-specific integrated circuit, a field-programmable gate array, a digital signal processor, or other suitable one or more hardware processors 110 and a software. The “software” may comprise one or more objects, agents, threads, lines of code, subroutines, separate software applications, two or more lines of code, or other suitable software structures operating in one or more software applications or the one or more hardware processors 110. The memory unit 112 is operatively connected to the one or more hardware processors 110. The memory unit 112 comprises the set of computer-readable instructions in form of a plurality of subsystems 114, configured to be executed by the one or more hardware processors 110.

In an exemplary embodiment, the one or more hardware processors 110 may include, for example, microprocessors, microcomputers, microcontrollers, digital signal processors, central processing units, state machines, logic circuits, and/or any devices that manipulate data or signals based on operational instructions. Among other capabilities, the one or more hardware processors 110 may fetch and execute computer-readable instructions in the memory unit 112 operationally coupled with the computer-implemented system 102 for performing tasks such as traffic routing, IP translation, and security policy enforcement, and/or any other functions. Any reference to a task in the present disclosure may refer to an operation being or that may be performed on data. The one or more hardware processors 110 is high-performance processors capable of handling large volumes of data and complex computations. The one or more hardware processors 110 may be, but not limited to, at least one of: multi-core central processing units (CPU), graphics processing units (GPUs), and specialized Artificial Intelligence (AI) accelerators that enhance an ability of the computer-implemented system 102 to process real-time data from one or more sources simultaneously.

In an exemplary embodiment, the one or more databases 104 may configured to store, and manage data related to various aspects of the computer-implemented system 102. The one or more databases 104 may store at least one of: one or more security policies and instructions, IP address translation tables, traffic logs and network activity, threat intelligence and reputation data, user-defined domain name system (DNS) instructions, one or more virtual local area network (VLAN) tags information, encryption keys and virtual private network (VPN) tunnel information, anomaly detection and incident reports, and the like. The one or more databases 104 may be regularly updated and synchronized across multiple carrier edge nodes 108 to ensure consistency and availability of critical information. Additionally, the one or more databases 104 may be configured to provide rapid access to stored data for real-time processing, enabling the computer-implemented system 102 to dynamically adjust the one or more security policies and traffic management strategies based on the most current data available. The one or more databases 104 enable the computer-implemented system 102 to dynamically retrieve, analyze, and update the stored data in real-time, facilitating continuous performance evaluation and optimization optimize the dual-stack traffic processing and the cybersecurity services. The one or more databases 104 may include different types of databases such as, but not limited to, relational databases (e.g., Structured Query Language (SQL) databases), non-Structured Query Language (NoSQL) databases (e.g., MongoDB, Cassandra), time-series databases (e.g., InfluxDB), an OpenSearch database, and object storage systems (e.g., Amazon S3, PostgresDB).

In an exemplary embodiment, the one or more communication devices 106 are configured with one or more user associated with IPV6 addresses. The one or more communication devices 106 may be digital devices, computing devices, and/or networks. The one or more communication devices 106 may include, but not limited to, a mobile device, a smartphone, a personal digital assistant (PDA), a tablet computer, a phablet computer, a wearable computing device, a virtual reality/augmented reality (VR/AR) device, a laptop, a desktop, routers, play stations, Internet of Things (IoT) devices, and any other network-enabled devices that connect to the computer-implemented system 102 primarily using IPV6 addressing within an IPV6-only core network. Each communication device 106 of the one or more communication devices 106 is assigned the IPV6 address, enabling direct and unique identification within the network and allowing for efficient data routing and communication. The one or more communication devices 106 are capable of interacting with both IPV6 and IPV4 network services within the one or more network services 118 via each carrier edge node 108 of the one or more carrier edge nodes 108, which facilitates the translation of IPV6 addresses to IPv4 addresses when necessary. Through each carrier edge node 108, the one or more communication devices 106 may access legacy IPv4-based services that are not natively compatible with IPV6 addresses. Each carrier edge node 108 handles IP address translation using a network address translation 64 (NAT64) technology, ensuring that the IPV6-only devices with in the one or more communication devices 106 may seamlessly communicate with the IPV4 network services within the one or more network services 118 without requiring additional configurations on the one or more communication devices 106 side.

In an exemplary embodiment, the one or more communication devices 106 may be associated with, but not limited to, one or more service providers, one or more customers, an individual, an administrator, a vendor, a technician, a specialist, an instructor, a supervisor, a team, an entity, an organization, a company, a facility, a bot, any other user, and combination thereof. The entity, the organization, and the facility may include, but not limited to, an e-commerce company, online marketplaces, service providers, retail stores, a merchant organization, a logistics company, warehouses, transportation company, an airline company, a hotel booking company, a hospital, a healthcare facility, an exercise facility, a laboratory facility, a company, an outlet, a manufacturing unit, an enterprise, an organization, an educational institution, a secured facility, a warehouse facility, a supply chain facility, any other facility/organization and the like.

In an exemplary embodiment, the one or more communication networks 116 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fiber optic network, a satellite network, a cloud computing network, or a combination of networks. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth, ZigBee, long-range wide area network (LoRaWAN), satellite communication, radio frequency identification (RFID), 6G (sixth generation) networks, advanced IoT protocols, mesh networks, non-terrestrial networks (NTNs), and the like.

In an exemplary embodiment, the computer-implemented system 102 may be implemented by way of a single device or a combination of multiple devices that may be operatively connected or networked together. The computer-implemented system 102 may be implemented in hardware or a suitable combination of hardware and software.

Though few components and the plurality of subsystems 114 are disclosed in FIG. 1, there may be additional components and subsystems which is not shown, such as, but not limited to, ports, routers, repeaters, firewall devices, network devices, the one or more databases 104, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the computer-implemented system 102, and the one or more communication devices 106 connected to the one or more databases 104, one skilled in the art can envision that the computer-implemented system 102, and the one or more communication devices 106 may be connected to several user devices located at various locations and several databases via the one or more communication networks 116.

Those of ordinary skilled in the art will appreciate that the hardware depicted in FIG. 1 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the computer-implemented system 102 as is unique to the present disclosure or necessary for an understanding of the present disclosure is depicted and described. The remainder of the construction and operation of the computer-implemented system 102 may conform to any of the various current implementations and practices that were known in the art.

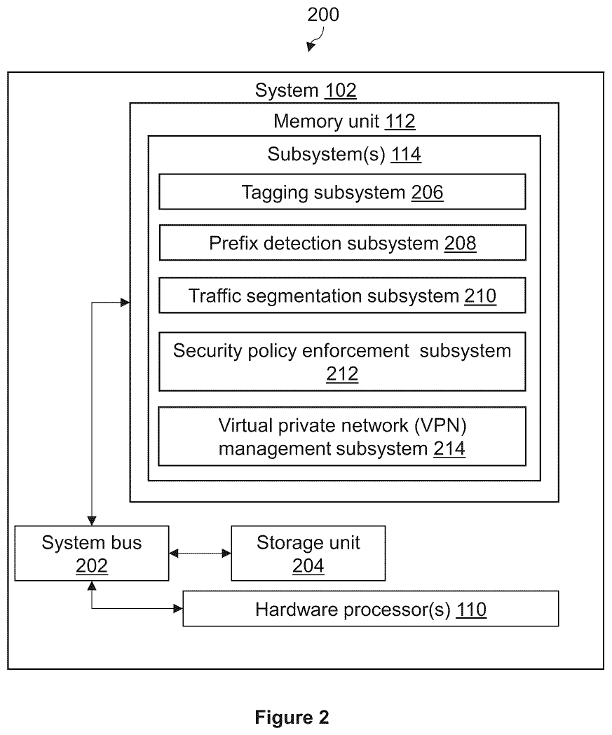

FIG. 2 illustrates an exemplary block diagram representation 200 of the computer-implemented system 102 as shown in FIG. 1 for providing cybersecurity services in dual-stack traffic processing within the one or more communication networks 116, in accordance with an embodiment of the present disclosure.

In an exemplary embodiment, the computer-implemented system 102 (hereinafter referred to as the system 102) comprises the one or more hardware processors 110, the memory unit 112, and a storage unit 204. The one or more hardware processors 110, the memory unit 112, and the storage unit 204 are communicatively coupled through a system bus 202 or any similar mechanism. The system bus 202 functions as the central conduit for data transfer and communication between the one or more hardware processors 110, the memory unit 112, and the storage unit 204. The system bus 202 facilitates the efficient exchange of information and instructions, enabling the coordinated operation of the system 102. The system bus 202 may be implemented using various technologies, including but not limited to, parallel buses, serial buses, or high-speed data transfer interfaces such as, but not limited to, at least one of a: universal serial bus (USB), peripheral component interconnect express (PCIe), and similar standards.

In an exemplary embodiment, the memory unit 112 is operatively connected to the one or more hardware processors 110. The memory unit 112 comprises the plurality of subsystems 114 in the form of programmable instructions executable by the one or more hardware processors 110. The plurality of subsystems 114 comprises a tagging subsystem 206, a prefix detection subsystem 208, a traffic segmentation subsystem 210, a security policy enforcement subsystem 212, and a virtual private network (VPN) management subsystem 214. The one or more hardware processors 110 associated, as used herein, means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory unit 112 may be the non-transitory volatile memory and the non-volatile memory. The memory unit 112 may be coupled to communicate with the one or more hardware processors 110, such as being a computer-readable storage medium. The one or more hardware processors 110 may execute machine-readable instructions and/or source code stored in the memory unit 112. A variety of machine-readable instructions may be stored in and accessed from the memory unit 112. The memory unit 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 112 includes the plurality of subsystems 114 stored in the form of machine-readable instructions on any of the above-mentioned storage media and may be in communication with and executed by the one or more hardware processors 110.

The storage unit 204 may be a cloud storage or the one or more databases 104 such as those shown in FIG. 1. The storage unit 204 is configured to store various types of data crucial for the operation and cybersecurity services provided by the system 102. Specifically, the storage unit 204 may store, but is not limited to, recommended course of action sequences dynamically generated by the system 102. These action sequences are based on real-time network traffic data analysis, security policy enforcement results, and threat intelligence assessments conducted by the plurality of subsystems 114. The recommended action sequences may include specific instructions for mitigating detected threats, such as isolating compromised devices within the one or more communication devices 106, blocking one or more malicious domains, adjusting firewall rules, and the like. The storage unit 204 may also store historical records of security incidents, which may be used to refine future responses by analyzing patterns in detected threats. Additionally, these action sequences may support automated responses, enabling the system 102 to proactively address security issues without manual intervention when predefined conditions are met. Beyond threat response, the storage unit 204 may maintain data on the configurations and status of the plurality of subsystems 114. This configuration data may include information on VLAN tag assignments, NAT64 prefix mappings, VPN tunnel parameters, and predefined security policies. By storing these configurations, the storage unit 204 allows for quick reconfiguration and system recovery in the event of a network change or failure. In addition, the storage unit 204 may store analytical data and performance metrics related to the dual-stack traffic processing. The analytical data includes statistics on the volume and types of traffic handled by the system 102, as well as logs of NAT64 translations and IPV6-to-IPv4 communication events. The storage unit 204 may be any kind of database such as, but not limited to, relational databases, dedicated databases, dynamic databases, monetized databases, scalable databases, cloud databases, distributed databases, any other databases, and a combination thereof.

In an exemplary embodiment, the one or more carrier edge nodes 108 are configured to transmit the traffic data packets between the one or more communication devices 106 and the one or more network services 118 within the one or more communication networks 116. The traffic data packets are individual units of data that are transmitted over a network. Each packet contains not only the payload (actual data being sent, such as part of an email, file, or webpage) but also header information. The header information is essential for routing and ensuring successful delivery. The traffic data packets are the units of data that the one or more carrier edge nodes 108 and other network components manage, secure, and route between the one or more communication devices 106 and the one or more network services 118.

Each carrier edge node 108 is further configured to handle the traffic data packets that needs to be directed to the IPV4 destinations. In this case, the system 102 is configured to prioritize the IPv4 addresses by transmitting the traffic data packets for the IPV4 destinations through the carrier edge nodes 108, while bypassing IPv6 addresses at each carrier edge node 108 until full IPV6 security policies are implemented. This selective handling ensures that IPv4 traffic is appropriately managed and secure while IPv6 traffic is initially bypassed to avoid conflicts or gaps in security policy coverage.

Additionally, each carrier edge node 108 incorporates Customer-side Translator (CLAT) functionality to support outbound traffic originating from the one or more communication devices 106 that contain only IPv6 addresses. In such cases, the carrier edge node 108 leverages a derived NAT64 prefix selected from one or more available NAT64 prefixes to synthesize compatible IPv6 addresses for the purpose of reaching IPv4 destinations. By using this derived NAT64 prefix, the carrier edge node 108 is able to convert the IPv6-based traffic into a format that is recognized by IPv4 services, thereby enabling effective communication with the IPV4 destinations despite the presence of an IPV6-only configuration on the originating one or more communication devices 106.

In an exemplary embodiment, the one or more network services 118 refers to at least one of: various digital services and resources that are accessible over the one or more communication networks 116. The one or more network services 118 may encompass a wide range of functionalities that the one or more users may access, interact with, or utilize over the one or more communication networks 116. Examples of such one or more network services 118 include, but are not limited to: web services, email services, file storage and sharing services, streaming services, application services, communication services, database services, one or more DNS services, and the like.

In an exemplary embodiment, the tagging subsystem 206 is configured to manage the dual-stack traffic within the system 102 for processing the dual-stack traffic in the one or more communication networks 116. The tagging subsystem 206 is configured to assign one or more virtual local area network (VLAN) tags to at least one of: the outbound communication device-originated data, and inbound communication device-originated data associated with the one or more communication devices 106. The tagging subsystem 206 is responsible for assigning the one or more VLAN tags to the traffic data packets. The one or more VLAN tags serve as identifiers that enable the system 102 to categorize and manage the traffic data packets effectively throughout their journey across the one or more communication networks 116. The primary purpose of the one or more VLAN tags is to identify the traffic data packets for the enforcement of one or more security policies. By using the one or more VLAN tags, the system 102 is able to apply specific security policies based on the type of traffic and its originating source.

The one or more VLAN tags comprise at least one of a first tag, a second tag, a third tag, a fourth tag, and one or more additional VLAN tags. The first tag is configured to identify the outbound communication device-originated data for initial processing at each carrier edge node 108. This initial tagging is crucial for ensuring that the data packets are recognized as originating from a specific communication device 106 within the one or more communication devices 106 and are processed accordingly. The second tag is assigned to the outbound communication device-originated data from each carrier edge node 108 after one or more security policies are enforced. The second tag indicates that the data has undergone security checks and is now ready for transmission to the one or more network services 118. This step is essential for maintaining the integrity and security of the network traffic data as it traverses to the one or more network services 118.

The third tag is configured to identify the inbound communication device-originated data directed to the one or more communication devices 106 after the inbound communication device-originated data undergone processing at each carrier edge node 108. The third tag ensures that the inbound communication device-originated data is correctly routed to the specific communication device 106 within the one or more communication devices 106, facilitating effective data delivery. The fourth tag is assigned to the inbound communication device-originated data upon detection of the one or more malicious domains at each carrier edge node 108. The fourth tag signifies that the traffic data packets have been flagged for potential threats and may require special handling or additional security measures before they are transmitted to the one or more communication devices 106 from the one or more network services 118.

The one or more additional VLAN tags are configured to assign to at least one of: the outbound communication device-originated data, and the inbound communication device-originated data based on one or more predefined parameters. The one or more predefined parameters comprise at least one of: a type of application, one or more user roles, one or more traffic characteristics, destination Internet Protocol (IP) address, security requirements, network conditions, real-time threat intelligence, and the like.

In an exemplary embodiment, the prefix detection subsystem 208 is configured to translate the IPV6 addresses associated with the outbound communication device-originated data to corresponding the IPV4 addresses. The translation is achieved using one or more NAT64 prefixes. The NAT64 prefix acts as a bridge between the IPV6 addresses and the IPV4 addresses, allowing IPv6-only communication devices 106 of the one or more communication devices 106 to communicate with IPv4-only destinations. By utilizing the one or more NAT64 prefixes, the prefix detection subsystem 208 facilitates the conversion of IPV6 data into a compatible format that is able to interact with the IPV4 destinations within the one or more communication networks 116, thereby ensuring seamless connectivity and interoperability.

The prefix detection subsystem 208 is configured to query one or more DNS servers to assist in the translation process. When the IPV6 address needs to be translated, the prefix detection subsystem 208 queries the DNS servers to determine the associated NAT64 prefix within the one or more NAT64 prefixes to use. This is done by deriving the NAT64 prefix from within the one or more NAT64 prefixes associated with an authorized IPv4 destinations linked to the one or more network services 118. This functionality ensures that the prefix detection subsystem 208 is able to dynamically identify and apply the associated NAT64 prefix required to access the specific IPv4 destination requested by the specific communication device 106 within the one or more communication devices 106.

The prefix detection subsystem 208 is further configured to automatically update the associated NAT64 prefixes based on real-time DNS queries. This dynamic update capability is essential for maintaining compatibility with updated IPv4 destinations that may be added or modified within the one or more network services 118 over time. By performing real-time queries to the DNS servers, the prefix detection subsystem 208 ensures that the one or more NAT64 prefixes are always updated, thereby providing continuous and accurate translation for the IPv6-to-IPv4 communication. This process helps prevent potential disruptions and ensures that the system 102 is able to adapt to any changes in an IPV4 network environment.

In an exemplary embodiment, the traffic segmentation subsystem 210 is configured to segment at least one of: the outbound communication device-originated data, and the inbound communication device-originated data into one or more categories. The segmentation is based on the one or more predefined parameters that allow the traffic segmentation subsystem 210 to tailor its processing and security responses to the specific characteristics of the traffic. By categorizing data traffic, the system 102 is able to apply customized security strategies, prioritize certain types of traffic, and ensure efficient use of network resources. The one or more categories comprise, but not limited to, at least one of: DNS traffic data, enterprise traffic data, internet-bound traffic data, and intercepted traffic data. The DNS traffic data includes all data related to DNS queries and responses. The DNS traffic data is essential for resolving domain names to IP addresses, which is critical for initiating communication with the one or more network services 118. The enterprise traffic data that is bound for or originating from enterprise networks. The enterprise traffic data involves sensitive information and may require specific security protocols or compliance with enterprise policies. The internet-bound traffic data includes general traffic intended for internet destinations. The internet-bound traffic data may have diverse characteristics and is subjected to security checks, such as content filtering and malware detection, depending on the source or destination. The intercepted traffic data consists of data that has been intercepted for inspection, such as encrypted traffic decrypted for secure sockets layer (SSL) inspection. The intercepted traffic data may involve deeper security checks, including anomaly detection and intrusion prevention, to ensure that no malicious content is being transmitted. The traffic segmentation subsystem 210 ensures that data traffic is managed efficiently and securely within the one or more carrier edge nodes 108. By categorizing traffic according to the one or more parameters.

Each carrier edge node 108 is configured to route the DNS traffic data through the one or more DNS servers configured with user-defined DNS policies to the one or more communication devices 106 using the translated IPV6 addresses for communication with the one or more DNS servers for communicating with the IPV4 addresses. Each carrier edge node 108 is configured to perform reputation checks for both the IPV4 addresses and the IPV6 addresses associated with the DNS traffic data. By evaluating the trustworthiness of the IPV6 addresses and the IPV4 addresses, the system 102 is able to preemptively block or flag potentially harmful destinations, thereby enhancing security. Each carrier edge node 108 is configured to process the enterprise traffic data to convert the IPV6 addresses to the IPV4 addresses prior to encryption, for secure communication with the IPV4 addresses associated with the one or more network services 118. The translation ensures that IPv6-only enterprise traffic is able to securely access IPv4 enterprise resources while maintaining data integrity. Each carrier edge node 108 is configured to apply a network address translation (NAT) using the Small-Medium Business (SMB)-specific Virtual Internet Protocol (VIPs) addresses and route the enterprise traffic data through one or more secure tunnels according to the user-defined DNS instructions. This enables enterprise traffic data to appear as if it is originating from specific SMB-assigned VIPs, adding an additional layer of address abstraction and privacy for SMB networks. The use of SMB-specific VIPs ensures that each SMB client retains a unique and secure address space within the network. Each carrier edge node 108 is configured to decrypt and transmit the enterprise traffic data to the one or more communication devices 106 using a designated VLAN tag within the one or more VLAN tags for managing the segmented at least one of: the outbound communication device-originated data, and the inbound communication device-originated data. The one or more VLAN tags ensures that each data packet is processed in accordance with its category and security requirements.

The tagging subsystem 206 is further configured to assign the second tag for outbound internet-bound traffic data within the internet-bound traffic data for external transmission. The tagging subsystem 206 is further configured to assign the fourth tag for inbound internet-bound traffic data within the internet-bound traffic data after decrypted for transmitting the traffic data packets to the one or more communication devices 106 from the one or more network services 118. The traffic segmentation subsystem 210 is configured with a secure sockets layer (SSL) interception module. The SSL interception module is configured to manage the intercepted traffic data through an IPV6-capable SSL proxy for generating outbound intercepted traffic data after the detection of the one or more malicious domains for transmitting to the one or more communication devices 106. The SSL proxy is fully compatible with the IPv6 addresses, allowing it to process both the IPv6 addresses and the IPV4 addresses as necessary, and is particularly effective for examining encrypted data that might otherwise bypass security checks.

In an exemplary embodiment, the security policy enforcement subsystem 212 is configured to dynamically enforce the one or more security policies on the segmented at least one of: the outbound communication device-originated data, and the inbound communication device-originated data. The security policy enforcement subsystem 212 ensures that all traffic within the one or more communication networks 116 adheres to specified security protocols and protection measures, thereby enabling robust cybersecurity services within the dual-stack (IPv4 and IPV6) traffic environment. By dynamically applying the one or more security policies, the security policy enforcement subsystem 212 is able to adjust its security measures in real-time based on traffic characteristics, allowing for immediate response to potential threats and alignment with network conditions or specific user requirements.

The enforcement of the one or more security policies is based on at least one of: the one or more VLAN tags and the one or more predefined parameters that are previously assigned to the traffic data packets. The one or more security policies comprise at least one of: firewall policies, intrusion detection and prevention policies, reputation-based filtering policies, access control policies, data encryption policies, malicious domain detection policies, content filtering policies, application-specific policies, bandwidth management policies, and compliance policies.

The security policy enforcement subsystem 212 is configured to detect the one or more malicious domains based on the one or more security policies in the traffic data packets for providing the cybersecurity services in the dual-stack traffic processing within the one or more communication networks 116. This detection process is based on the defined security policies that specify actions to be taken when the one or more malicious domains are identified. By intercepting and acting upon the traffic data packets associated with the one or more malicious domains, the security policy enforcement subsystem 212 contributes to the overall cybersecurity posture of the one or more communication networks 116.

In an exemplary embodiment, the VPN management subsystem 214 is configured to encapsulate the IPV4 addresses within the IPV6 addresses. The encapsulation process allows the VPN to tunnel IPv4-based traffic over an IPV6-only network by wrapping IPv4 packets within IPV6 headers. The encapsulation ensures that the IPv4 addresses are compatible with the IPV6 network environment, allowing the system 102 to maintain end-to-end IPv4 addresses communication even when the transport network does not natively support IPv4 addresses. This process is essential for facilitating secure connections to IPv4-only destinations from within an IPV6-only network environment. The VPN management subsystem 214 is also responsible for generating one or more VPN tunnels using IPv6 addresses. The one or more VPN tunnels create secure, encrypted pathways for transmitting traffic data packets through the IPV6 network while ensuring compatibility with IPv4 communication endpoints. By leveraging IPV6 addresses for the one or more VPN tunnels creation, the VPN management subsystem 214 utilizes the IPV6 addresses to maintain privacy and integrity of the data. This approach enables encapsulated IPv4 addresses to traverse securely, mitigating the risks associated with data interception or unauthorized access. Once the one or more VPN tunnels are established, the VPN management subsystem 214 uses it to transmit traffic data packets to and from IPv4 addresses. The VPN management subsystem 214 handles the conversion and encapsulation needed for each data packet, ensuring that the VPN management subsystem 214 maintains its IPv4 addresses compatibility while being transported over the IPV6 compatible the one or more VPN tunnels. This capability allows the one or more communication devices 106 operating within an IPV6-only environment to securely access IPv4 resources without requiring native IPv4 support within the network infrastructure. As a result, the one or more users are able to connect to legacy IPv4 applications and services through the one or more VPN tunnels without any interruptions or compatibility issues.

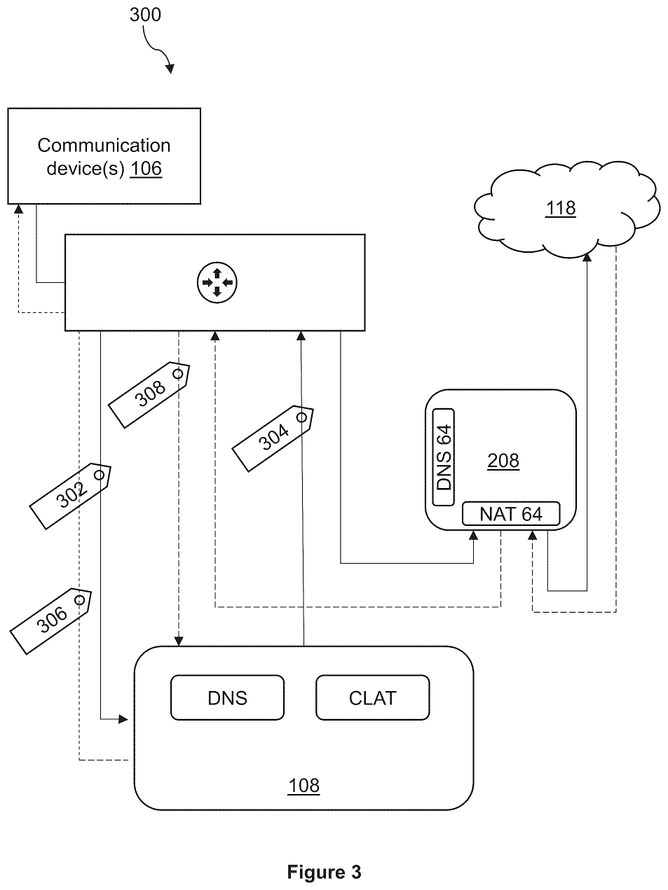

FIG. 3 illustrates an exemplary first process flowchart 300 of the computer-implemented system 102 for the dual-stack traffic processing, in accordance with an embodiment of the present disclosure;

In an exemplary embodiment, the one or more communication devices 106 is configured to send data while browsing the internet or using applications by using the one or more communication networks 116, all the traffic data packets are routed through each carrier edge node 108. Each carrier edge node 108 is configured to assign the first tag 302 in the tagging subsystem 206 to the outbound communication device-originated data. The first tag 302 is called VLAN TAG-SUBS_ORIG. Each carrier edge node 108 is a central node that manages and directs the traffic data packets of the one or more communication devices 106. To ensure that the traffic data packets flows smoothly. The one or more VLAN tags acts like a special marker that helps the one or more carrier edge nodes 108 identify and handle the traffic data packets appropriately.

For at least one of: the outbound communication device-originated data, and the inbound communication device-originated data, each carrier edge node 108 of the one or more carrier edge nodes 108 applies the second tag 304. The second tag 304 is called SUBS_ORIG_EGRESS. The second tag 304 tells the system 102, this traffic data packets is coming from the one or more communication devices 106 and needs to be processed accordingly. The prefix detection subsystem 208, which is responsible for directing the traffic data packets, recognizes the second tag 304 and uses normal IPV6 routing for the data traffic with the SUBS_ORIG_EGRESS tag. In other words, it follows a specific path designated for at least one of: the outbound communication device-originated data, and the inbound communication device-originated data.

On the other hand, when traffic data packets is coming into the one or more communication networks 116, it is expected to be routed through each carrier edge node 108 of the one or more carrier edge nodes 108 using the third tag 308 called SUBS_TERM. The third tag 308 acts as a marker for the inbound communication device-originated data. Once each carrier edge node 108 of the one or more carrier edge nodes 108 processes the incoming data traffic, it applies a fourth tag 306 called SUBS_TERM_EGRESS. The fourth tag 306 is configured to indicate that the inbound communication device-originated data is processed and is ready to be routed to the one or more communication devices 106. The one or more carrier edge nodes 108 then routes the inbound communication device-originated data with the fourth tag 306 based on the IPV6 addresses, ensuring that the traffic reaches its intended destination within the one or more communication networks 116.

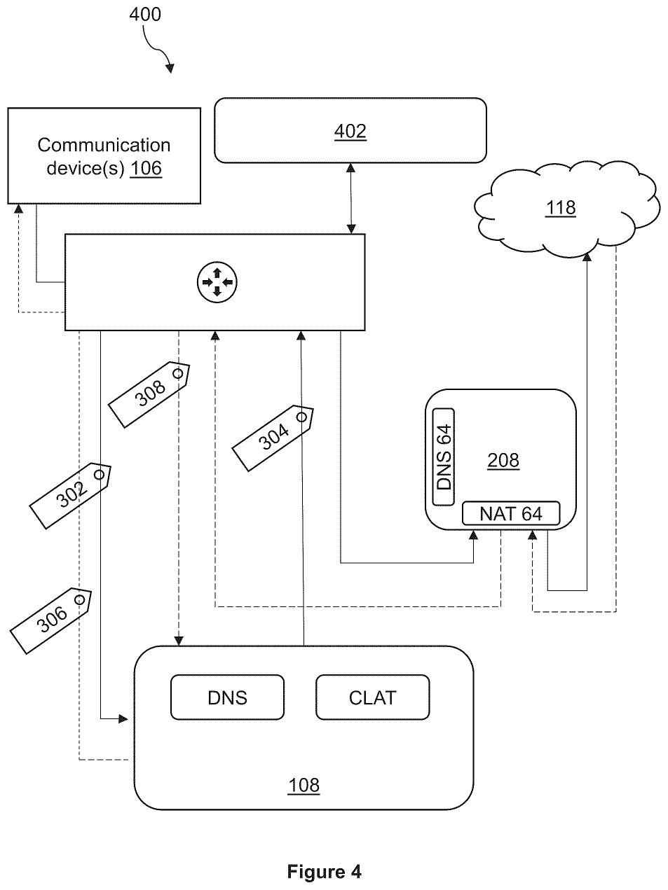

FIG. 4 illustrates an exemplary second process flowchart 400 of the computer-implemented system 102 for pure IPV6 that is not routed through the one or more carrier edge nodes 108, in accordance with an embodiment of the present disclosure.

In an exemplary embodiment, the system 102 distinguishes between IPv4 addresses and pure IPv6 addresses and handles them differently. The prefix detection subsystem 208 employs a mechanism where only the IPV4 destinations flows (those with the IPV4 address) are routed through the one or more carrier edge nodes 108, which acts as the central hub for processing and directing the traffic. A pure IPV6 environment 402, on the other hand, is bypassed at the prefix detection subsystem 208 itself. This means that the prefix detection subsystem 208 recognizes the pure IPV6 environment 402 and doesn't send it to the one or more carrier edge nodes 108 for further processing. Instead, it directly handles and routes the pure IPv6 environment 402 according to normal IPv6 routing protocols.

To support the IPV6 addresses, the system 102 is configured with the NAT 64 called Prefix64::/n discovery. This means that the one or more carrier edge nodes 108 need to identify the IPV6 Prefix64::/n in the one or more communication networks 116. This Prefix64::/n helps in identifying synthesized IPv6 destinations and allows the application of any specific policies for the corresponding IPv4 addresses. The purpose of discovering the IPV6 addresses, the Prefix64::/n is to enable communication with the one or more network services 118. This is particularly important for control services or enterprise traffic data that is needed to communicate with IPv4-based peers associated with the one or more network services 118. By knowing the Prefix64::/n, the one or more carrier edge nodes 108 are able to apply the necessary translation or routing rules to facilitate communication between the IPv4 addresses and IPV6 addresses.

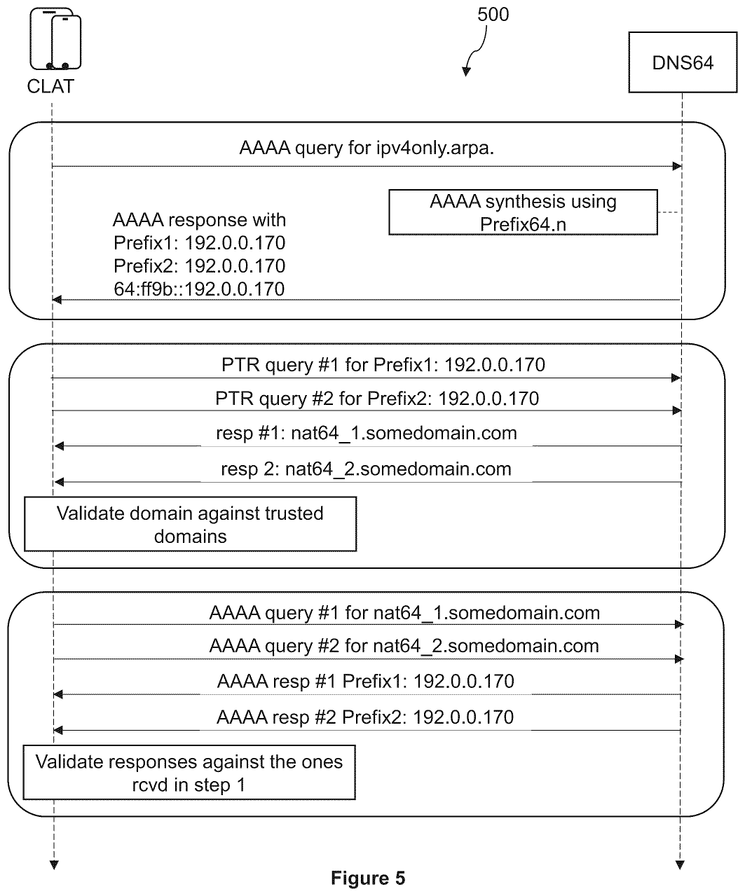

FIG. 5 illustrates an exemplary flowchart of prefix detection and validation 500, in accordance with an embodiment of the present disclosure.

In an exemplary embodiment, the prefix detection subsystem 208 is implemented to determine the Prefix64::/n within the one or more NAT 68 prefixes, which is crucial for the dual-stack traffic processing. The prefix detection subsystem 208 starts by querying the one or more DNS servers to resolve a well-known fully qualified domain name (FQDN) called ipv4only.arpa. This FQDN is a recognized standard and is used for retrieving information related to IPv4-only addresses. Once the resolution is successful, the discovery service sends a PTR (Pointer) record query for the received answer records. This query aims to retrieve the reverse DNS (PTR) record associated with the IPv4 addresses.

The retrieved PTR response is then validated against a list of trusted domains that have been pre-configured. This validation ensures that the response is genuine and associated with the intended trusted domains. After validating the PTR response, the discovery service sends an AAAA query. This query is used to retrieve the IPV6 address associated with the PTR response(s). The retrieved AAAA answer record(s) is validated against the answer received in the well-known FQDN (ipv4only.arpa). This validation ensures that the IPV6 address corresponds to the expected mapping based on the IPV4 address. Once the AAAA answer record(s) are successfully validated, the prefix detection subsystem 208 derives the desired prefix (Prefix64::/n) from the AAAA answer record(s). This prefix is then used for the dual-stack traffic processing (IPv4-to-IPv6 translation) and routing purposes. The discovery process is repeated at regular intervals, as configured, to check for any changes or updates to the Prefix64::/n. This allows the one or more communication networks 116 to adapt to any modifications in the network configuration or prefix mappings efficiently.

For instance, IPV6 Prefix Identification PHASE-1, CRE_V6_PFX_ID-01, the one or more carrier edge nodes 108 are deployed in IPV6-only mode, the configuration shall include carrier DNS address to be used as the one or more DNS servers. The one or more DNS servers shall be used for the one or more carrier edge nodes 108 initiated DNS requests as well as the DNS requests forwarded by the one or more carrier edge nodes 108. CRE_V6_PFX_ID-02 Prefix identification shall be done using the well-known FQDN ipv4only.arpa. CRE_V6_PFX_ID-03 NAT64 prefix FQDN shall be determined using the PTR query for the AAAA record received for Well-Known Filters (WKF). CRE_V6_PFX_ID-04 Further validation of Prefix-64 is done by comparing the AAAA record received for NAT64 prefix FQDN and the AAAA records received for well-known FQDNs. CRE_V6_PFX_ID-05 This prefix identification process is repeated once in a while to determine any change in the prefix value (low priority).

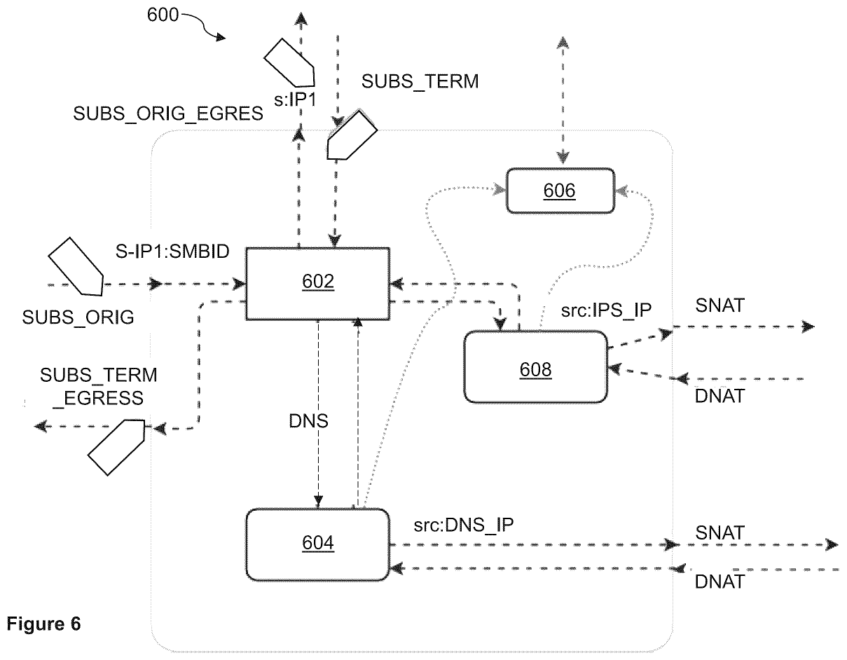

FIG. 6 illustrates an exemplary service management block 600, in accordance with an embodiment of the present disclosure.

In an exemplary embodiment, inside the one or more carrier edge nodes 108, packet routing is performed based on different paths and considerations. In the subscriber originated data, data from subscribers is received with the first tag 302 called SUBS_ORIG. The mapping of subscribers' {IP, MDN_ID, SMB_ID} is obtained out-of-band, and the method of obtaining this mapping vary for each communication network 116 within the one or more communication networks 116. Based on the mapping, subscriber-originated data is routed to a specific SMB namespace 602. If the SMB namespace 602 for a particular subscriber does not exist at the time of packet arrival, the one or more carrier edge nodes 108 creates a new network namespace for that SMB. Incoming traffic is taking four paths from within the SMB namespace 602, such as DNS request handling, the DNS traffic data, the enterprise traffic data, the internet-bound traffic data, and the intercepted traffic data. Other than the above-mentioned paths, mirrored traffic is subjected to offline analysis (IDS) 608.

In the DNS request handling, DNS requests are routed to the one or more DNS services 604. If the user-defined domain name system (DNS) instructions (based on fully qualified domain names-FQDNs) are installed in the SMB namespace 602, the traffic may be routed to enterprise peers defined in those rules. The one or more DNS services 604 acts as a proxy and generate requests to configure the one or more DNS services 604. Egress DNS requests are routed with the one or more DNS services 604 as the source. If the one or more DNS services 604 are configured with IPv4 literals (explicit IPv4 addresses), a synthesized IPv6 address is used as the DNS server 604 address. Reputation handling is performed for the FQDNs in DNS requests, In case AAAA records received in the responses are synthesized addresses, corresponding IPv4 addresses. IP routing rules are created with both the IPV6 (source) and destination addresses. Note that the IP routing rules are created with the v6 (source) & destination addresses as well.

For instance, if a particular IPv4 address is marked for blocking due to any policy or being blacklisted site, the corresponding synthesized v6 address(es) is (are) also blacklisted and vice versa. In case the AAAA record is the pure V6 address, a reputation check is performed for the V6 address. The reputation check interface shall be enhanced to support IPV6 addresses. Reputation Score PHASE-2, CRE_V6_RS_01 If the destination address contains the Prefix-64, the v4 address is extracted from the v6 address, and the reputation score for the v4 address is queried. CRE_V6_RS_02 In case Prefix-64 is not present, (pure IPv6 scenario), reputation lookup is done for the IPV6 address. CRE_V6_RS_03 The IP table rules shall now include IPv6 source and destination.

In the enterprise traffic, If the enterprise peer is IPv4-based, the one or more carrier edge nodes 108 need to convert the IPV6 addresses to the IPV4 addresses before encrypting the traffic and sending it to the peer using a locally synthesized address. An SMB VIP (Virtual IP) from a VIP manager is used for the NAT of the internal traffic data packet. If the DNS request matches an enterprise FQDN rule (if one exists), the request is routed through a tunnel based on the destination of the enterprise DNS rule. Response packets destined for the user are received with the third tag 308 and routed to the corresponding SMB's Service Engine (SE). Packets are decrypted and sent to the one or more communication devices 106 based on the IPv4 destinations. The one or more communication devices 106 destined packets are transmitted with the VLAN tag SUBS_TERM_EGRESS.

On the internet-bound traffic, the internet-bound traffic that is not intercepted is sent out from the SMB namespace 602. The source IP address remains unchanged. The VLAN tag SUBS_ORIG_EGRESS is used for internet-bound traffic. Response data (communication devices 106 terminating traffic) is received using the SUBS_TERM VLAN tag and routed to the corresponding SMB namespace 602. Packets are decrypted and sent to the one or more communication devices 106 based on the IPV4 destinations. The one or more communication devices 106 destined packets are sent with the VLAN tag SUBS_TERM_EGRESS.

The intercepted traffic is associated with the one or more carrier edge nodes 108. Traffic interceptors within the one or more network services 118 are needed to support IPV6 addresses. The SSL Proxy is enhanced to support IPv6 addresses. Qosmos (traffic classification engine) and Suricata (intrusion detection system) need to support IPv6 addresses. The SSL proxy terminates and generates egress traffic. The SSL Proxy's local address is used as the source for the egress traffic and undergoes source the NAT using the one or more carrier edge nodes 108 WAN address, followed by Carrier NAT using a public address. Response packets are Destination NATted (DNATted) in reverse order and reach the SSL Proxy through connection tracking (contrak). The response is sent on the ingress leg of the SSL proxy to reach the SMB SE. Packets reach the one or more communication devices 106 based on the IPV4 destinations and use the VLAN tag SUBS_TERM_EGRESS. V6 Support in Traffic Interceptor I PHASE-2, CRE_V6_TI_01 Traffic interceptor should support V6, V6 traffic interception.

A control path traffic, If the control path is IPv4-addresses, the one or more carrier edge nodes 108 synthesizes the IPV6 address using the prefix learned during discovery. This IPV6 address is used for control path interfaces such as RSM (Routing and Switching Module), logging interfaces, and CM (Configuration Manager) when the control service address is not resolved through DNS. DNS64 (DNS protocol extension) within the one or more carrier edge nodes 108 are expected to return synthesized records.

If the mirrored traffic is subjected to the offline analysis (IDS) 608, NATting (Network Address Translation) to a private IP address using the VIP manager may not be necessary if the source IP address is IPV6 addresses. For each incoming IPv6 flow, if the destination IPv4 address is found to be a synthesized address, security services are applied to the corresponding IPv4 address. RSA (Remote Server Administration) 606 includes the IPv4 address in the metadata shared with RSM. Redis data structures are enhanced to support the IPv6 addresses.

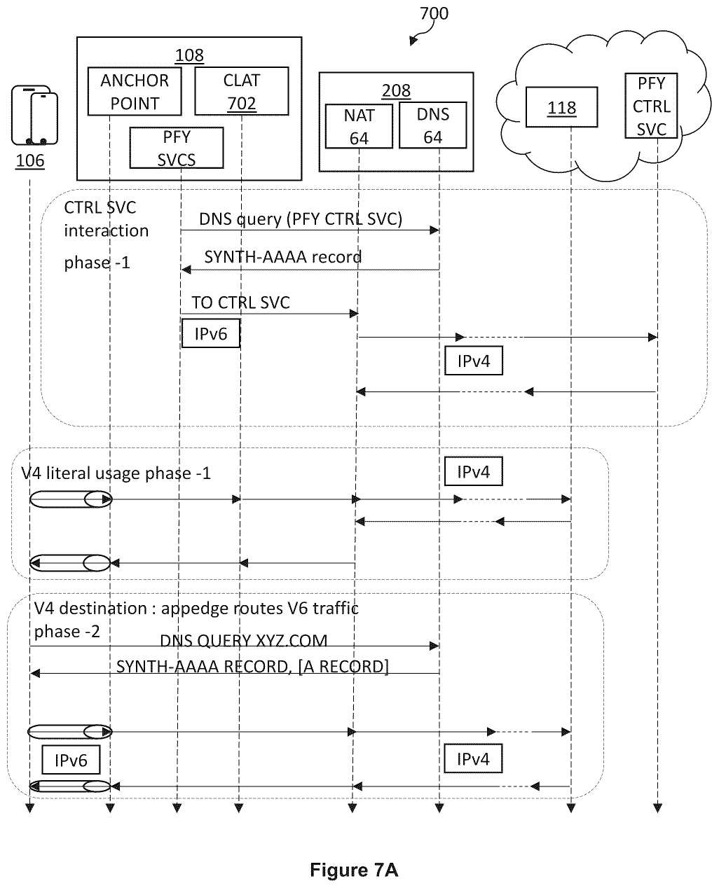

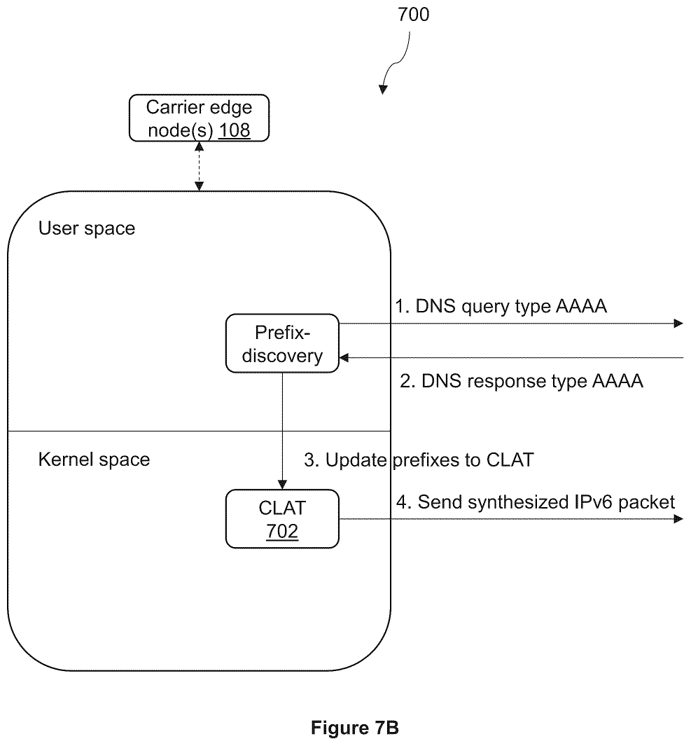

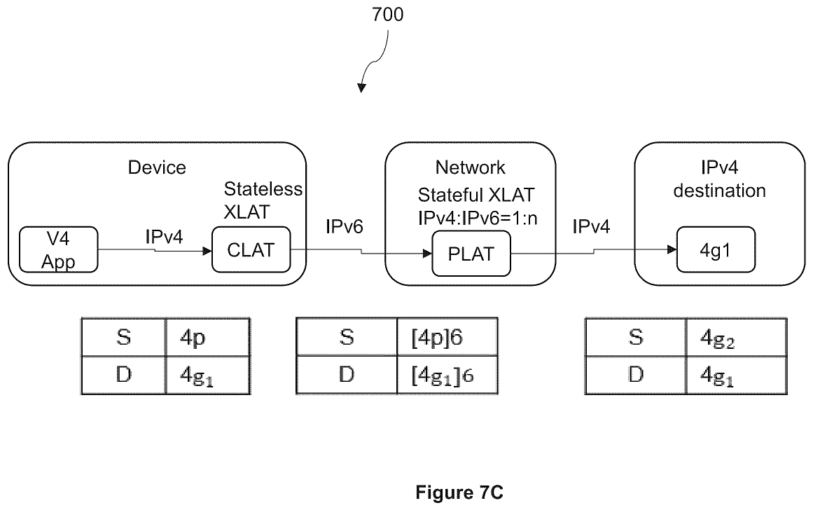

FIG. 7A illustrates an exemplary flowchart of IPV6 support in the one or more carrier edge nodes 108 for an AppEdge-based anchoring 700, in accordance with an embodiment of the present disclosure.

FIG. 7B illustrates an exemplary block diagram of the one or more carrier edge nodes 108 for the AppEdge-based anchoring 700, in accordance with an embodiment of the present disclosure.

FIG. 7C illustrates an exemplary block diagram of the customer-side translator (CLAT) 702 functionality within the one or more carrier edge nodes 108, in accordance with an embodiment of the present disclosure.

In an exemplary embodiment, the one or more communication devices 106 are operatively connected to the one or more carrier edge nodes 108 using an AppEdge, the inner packets initially use only IPv4 addresses in the initial phase. The one or more carrier edge nodes 108 are configured with either an IPV4 network or the pure IPv6 environment 402. If the one or more carrier edge nodes 108 are configured with the IPV4 addresses, no specific handling is required for traffic destined for the IPV4 addresses. The one or more carrier edge nodes 108 is able to route the IPV4 addresses as usual, without any additional translation or conversion. In the case where the one or more carrier edge nodes 108 does not have IPv4 connectivity and operates in the pure IPv6 environment 402, it needs to support the CLAT 702 functionality for egress traffic. The one or more carrier edge nodes 108 discover the prefix-64 for the one or more network services 118, which is used to derive the IPV6 addresses. When the one or more network services 118 with IPv4 addresses are encountered, the one or more carrier edge nodes 108 synthesize the corresponding IPV6 address using the prefix-64. This synthesized IPv6 address is used to communicate with the one or more network services 118. The CLAT 702 function allows the one or more carrier edge nodes 108 to bridge the gap between the IPV6 addresses and the IPV4 destinations, enabling communication between the two protocols.

The VPN-based one or more communication devices Anchoring: the one or more carrier edge nodes 108 in the Pure IPV6 Environment 402 PHASE-1, CRE_V6_VPN_01 Carrier Edge shall support the CLAT 702 functionality to route IPv4 destined traffic over IPv6 It may synthesize the IPV6 address corresponding to the IPv4 destination using the Prefix64::/n discovered network. The CLAT 702 functionality is preferably implemented as a Kernel module than a user-space service, for performance reasons. CRE_V6_GEN_02 the one or more carrier edge nodes 108 may use the AAAA answer records received from the DNS64, to reach the control services.

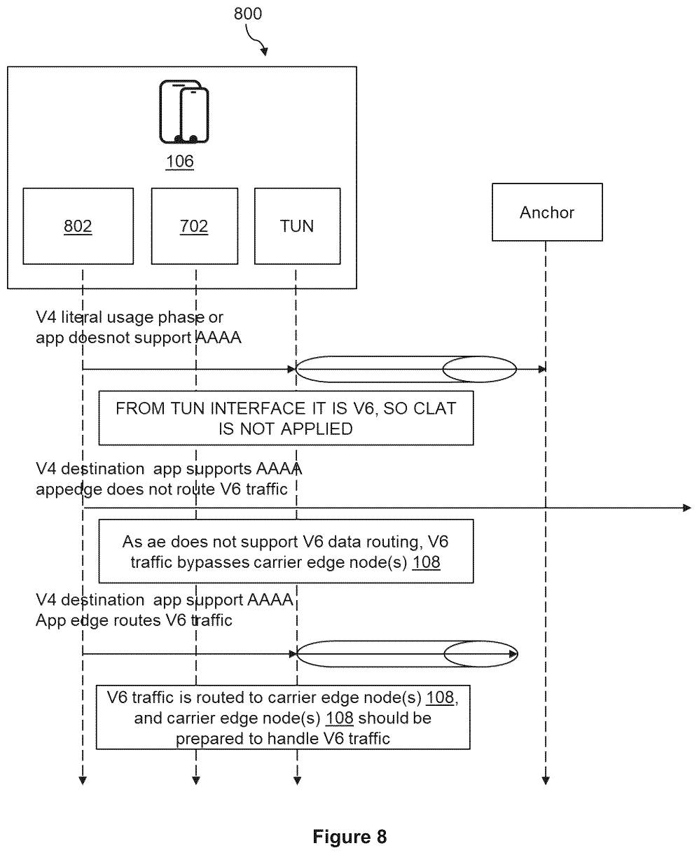

FIG. 8 illustrates an exemplary flowchart of packet flows 800 within the one or more communication devices 106 with the IPV6 addresses, in accordance with an embodiment of the present disclosure.

In an exemplary embodiment, the AppEdge 802 is running on the one or more communication devices 106, the data packet routing inside the one or more communication devices 106 depends on the type of traffic and the AppEdge's 802 support for the IPV6 addresses. If the one or more communication devices 106 need to communicate with the IPv4 destinations, the CLAT 702 on the one or more communication devices 106 is expected to translate the traffic from the IPV6 addresses to the IPv4 addresses. The CLAT 702 performs the necessary protocol translation to enable communication with the one or more network services 118.

If the traffic from the one or more communication devices 106 matches the tunnel routing rules defined by the AppEdge 802, it uses the IPV6 addresses for communication. However, in this scenario, the data traffic packets of the traffic will still be in IPV4 format. The AppEdge 802 establishes the IPV6 addresses to carry the IPv4 addresses, allowing it to traverse the one or more network services 118. Until the AppEdge 802 supports routing IPV6 addresses through one or more tunnels, the IPV6 addresses are bypassed by the one or more carrier edge nodes 108. This means that IPv6 addresses may be handled outside of the one or more carrier edge nodes 108 and follow regular IPv6 routing mechanisms. The one or more communication devices 106 treats the IPV6 addresses as it would for a direct connection without the one or more carrier edge nodes 108.

Once the AppEdge 802 starts routing the IPV6 addresses through the one or more carrier edge nodes 108, the traffic data packets is treated similarly to direct-connect the IPV6 addresses. The inner traffic data packets are still in the IPv4 addresses format, but the AppEdge 802 is able to handle the encapsulation and decapsulation of the traffic data packets for routing through the IPV6 addresses.

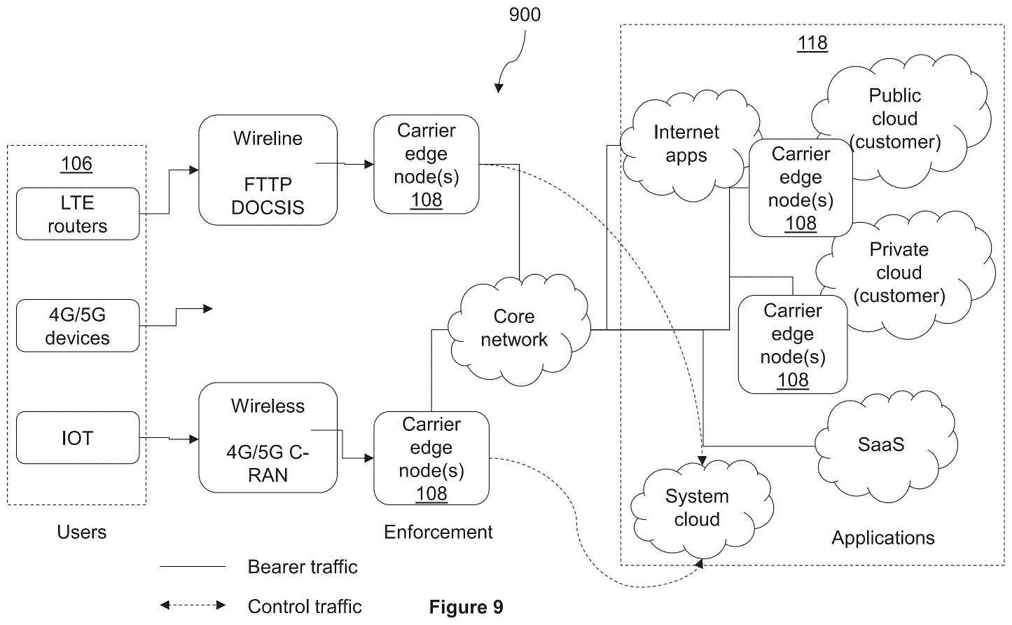

FIG. 9 illustrates an exemplary block diagram of the system architecture view 900, in accordance with an embodiment of the present disclosure.

In an exemplary embodiment, the system architecture view 900 depicts a traffic flow. The traffic data packets are routed to the one or more carrier edge node 108, which is configured to identify the traffic data packets and apply both user-defined security policies and system-defined security policies. The security policy enforcement subsystem 212 within the one or more carrier edge nodes 108 dynamically enforces the one or more security policies based on the one or more VLAN tags and the one or more predefined parameters associated with each packet within the traffic data packets, ensuring that appropriate security measures are applied according to the traffic segmentation subsystem 210.

The one or more carrier edge nodes 108 is further equipped to provide detailed network insights and visibility at the one or more users. These insights, which include data on traffic patterns and security events, may be distributed to the service provider's Security Information and Event Management (SIEM) and Security Orchestration, Automation, and Response (SOAR) systems, enabling enhanced monitoring, analysis, and automated response capabilities. In this typical use case, the one or more users are not required to install any software on their one or more communication devices 106, such as mobile devices or home routers, nor are they required to deploy any additional equipment at their home or office locations. The system 102 is configured to operate seamlessly within the one or more communication networks 116, leveraging the one or more carrier edge nodes 108 to manage and secure traffic data packets. The only action required from the one or more users is to enable the cybersecurity services and, if desired, to define security policies for their specific traffic flows. Once enabled, the system 102 automatically applies the user-defined security policies and the system-defined security policies to the user's data, ensuring a secure and efficient processing at least one of: outbound communication device-originated data, and inbound communication device-originated data without any need for direct user intervention or additional installations on user devices.

The one or more carrier edge nodes 108 also be deployed in data centers outside the core network to avoid requiring modifications to the existing network infrastructure. This setup represents an alternative deployment configuration, suited for scenarios where Over-the-Top (OTT) service providers deliver security services independently of the one or more communication networks 116. In the second deployment configuration, traffic data from the one or more communication devices 106, such as mobile devices, is securely transmitted to the one or more carrier edge nodes 108 through an always-on secure connection established directly on the one or more communication devices 106. This connection may be facilitated by an application installed on the one or more communication devices 106, enabling persistent and secure access to the system 102 services.

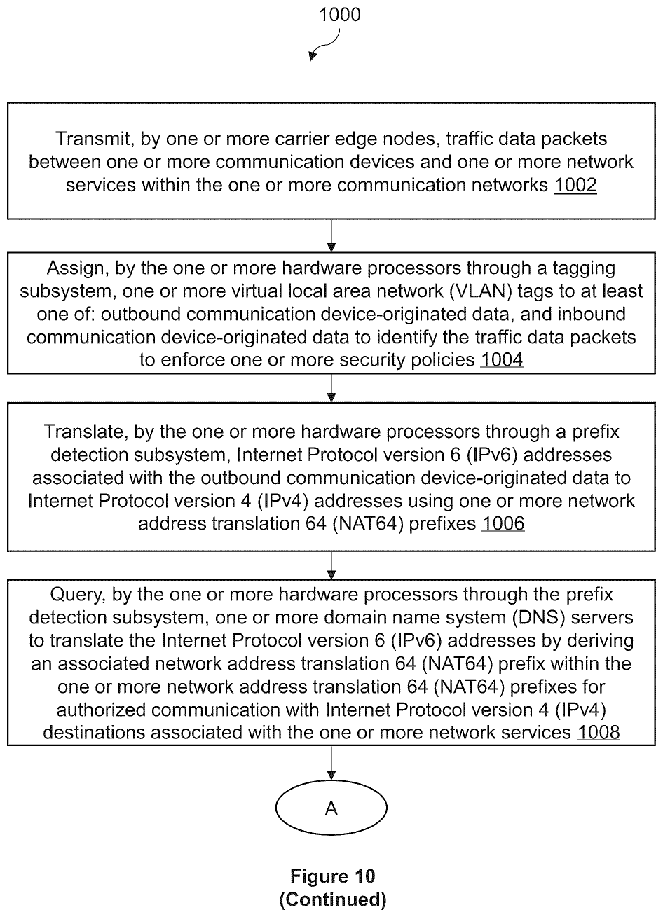

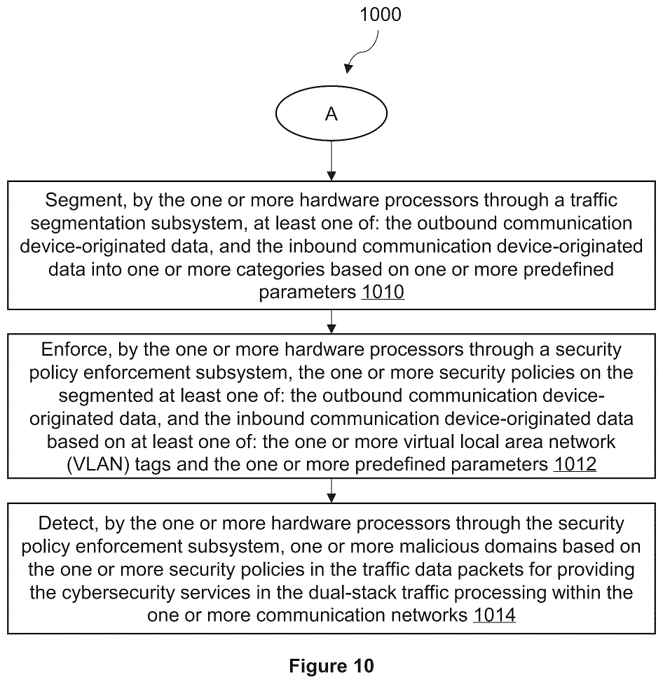

FIG. 10 illustrates an exemplary flow chart of a computer-implemented method 1000 for providing cybersecurity services in dual-stack traffic processing within the one or more communication networks 106, in accordance with an embodiment of the present disclosure.

According to another exemplary embodiment of the present disclosure, the computer-implemented method 1000 for providing cybersecurity services in dual-stack traffic processing within the one or more communication networks is disclosed. At step 1002, the computer-implemented method 1000 includes transmitting, by the one or more carrier edge nodes, the traffic data packets between the one or more communication devices and the one or more network services within the one or more communication networks. Each carrier edge node of the one or more carrier edge nodes is configured to transmit the traffic data packets to the IPv4 destinations through the one or more carrier edge nodes. While bypassing the IPV6 addresses at each carrier edge node of the one or more carrier edge nodes until the complete IPV6 security policies are enforced. Each carrier edge node of the one or more carrier edge nodes is further configured to provide the CLAT functionality for the outbound communication device-originated data with only the IPV6 addresses, using the derived NAT64 prefix within one or more NAT64 prefixes to synthesize the IPV6 addresses for the IPV4 destinations.

At step 1004, the computer-implemented method 1000 includes assigning, by the one or more hardware processors through the tagging subsystem, the one or more VLAN tags to at least one of: the outbound communication device-originated data, and the inbound communication device-originated data to identify the traffic data packets to enforce the one or more security policies. The one or more VLAN tags comprise the first tag (VLAN TAG-SUBS_ORIG), the second tag (SUBS_ORIG_EGRESS), the third tag (SUBS_TERM), the fourth tag (SUBS_TERM_EGRESS), and the one or more additional VLAN tags.

At step 1006, the computer-implemented method 1000 includes translating, by the one or more hardware processors through the prefix detection subsystem, the IPv6 addresses associated with the outbound communication device-originated data to IPv4 addresses using one or more NAT64 prefixes. At step 1008, the computer-implemented method 1000 includes querying, by the one or more hardware processors through the prefix detection subsystem, the one or more DNS servers to translate the IPV6 addresses by deriving the associated NAT64 prefix within the one or more NAT64 prefixes for authorized communication with the IPV4 destinations associated with the one or more network services.

At step 1010, the computer-implemented method 1000 segmenting, by the one or more hardware processors through the traffic segmentation subsystem, at least one of: the outbound communication device-originated data, and the inbound communication device-originated data into the one or more categories based on the one or more predefined parameters. The one or more predefined parameters comprise at least one of: a type of application, one or more user roles, one or more traffic characteristics, destination Internet Protocol (IP) address, security requirements, network conditions, and real-time threat intelligence.

At step 1012, the computer-implemented method 1000 enforcing, by the one or more hardware processors through the security policy enforcement subsystem, the one or more security policies on the segmented at least one of: the outbound communication device-originated data, and the inbound communication device-originated data based on at least one of: the one or more VLAN tags and the one or more predefined parameters. At step 1014, the computer-implemented method 1000 includes detecting, by the one or more hardware processors through the security policy enforcement subsystem, the one or more malicious domains based on the one or more security policies in the traffic data packets for providing the cybersecurity services in the dual-stack traffic processing within the one or more communication networks. The one or more security policies comprise at least one of the: firewall policies, intrusion detection and prevention policies, reputation-based filtering policies, access control policies, data encryption policies, malicious domain detection policies, content filtering policies, application-specific policies, bandwidth management policies, and compliance policies.

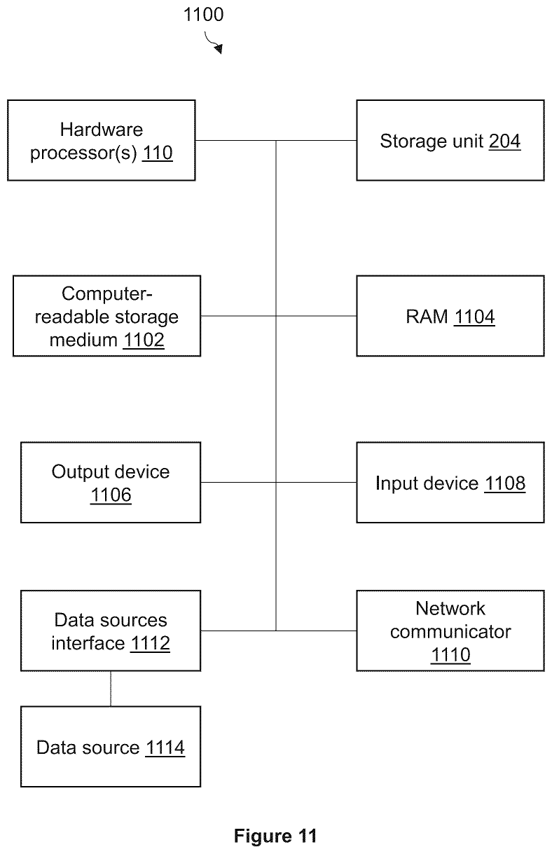

FIG. 11 illustrates an exemplary block diagram representation of one or more server platforms 1100 for implementation of the disclosed system 102, in accordance with an embodiment of the present disclosure.

In an exemplary embodiment, for the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the one or more server platforms 1100. As illustrated, the one or more server platforms 1100 may include additional components not shown, and some of the components described may be removed and/or modified. For example, a computer system with the multiple graphics processing units (GPUs) may be located on at least one of: internal printed circuit boards (PCBs) and external-cloud platforms including Amazon Web Services (AWS), Google Cloud Platform (GCP) Microsoft Azure (Azure), internal corporate cloud computing clusters, or organizational computing resources.

The one or more server platforms 1100 may be a computer system such as the system 102 that may be used with the embodiments described herein. The computer system may represent a computational platform that includes components that may be in the one or more hardware processors 110 or another computer system. The computer system may be executed by the one or more hardware processors 110 (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the one or more hardware processors 110 that execute software instructions or code stored on a non-transitory computer-readable storage medium 1102 to perform methods of the present disclosure. The software code includes, for example, instructions to gather data and analyze the network environment data. For example, the plurality of subsystems 114 includes the tagging subsystem 206, the prefix detection subsystem 208, the traffic segmentation subsystem 210, the security policy enforcement subsystem 212, and the virtual private network (VPN) management subsystem 214.

The instructions on the computer-readable storage medium 1102 are read and stored the instructions in the storage unit or random-access memory (RAM) 1104. The storage unit 204 may provide a space for keeping static data where at least some instructions could be stored for later execution. The stored instructions may be further compiled to generate other representations of the instructions and dynamically stored in the RAM 1104. The one or more hardware processors 110 may read instructions from the RAM 1104 and perform actions as instructed.

The computer system may further include an output device 1106 to provide at least some of the results of the execution as output including, but not limited to, visual information of the performance reports to the one or more users. The output device 1106 may include a display on computing devices and virtual reality glasses. For example, the display may be a mobile phone screen or a laptop screen. Graphical user interfaces (GUIs) and/or text may be presented as an output on the display screen. The computer system may further include an input device 1108 to provide the one or more users or another device with mechanisms for entering data and/or otherwise interacting with the computer system. The input device 1108 may include, for example, a keyboard, a keypad, a mouse, or a touchscreen. Each of the output devices 1106 and the input device 1108 may be joined by one or more additional peripherals.

A network communicator 1110 may be provided to connect the computer system to a network and in turn to other devices connected to the network including other entities, servers, data stores, and interfaces. The network communicator 1110 may include, for example, a network adapter such as a LAN adapter or a wireless adapter. The computer system may include a data sources interface 1112 to access a data source 1114. The data source 1114 may be an information resource about the IPV6 addresses and the IPV4 addresses. As an example, the one or more databases 104 of exceptions and rules may be provided as the data source 1114. Moreover, knowledge repositories and curated data may be other examples of the data source 1114. The data source 1114 may include libraries containing, but not limited to, network configuration files, threat intelligence feeds, IP address reputation databases, DNS records, the one or more security policies, and protocol mappings for both IPv4 addresses and IPV6 addresses. Additionally, the data source 1114 may encompass information repositories and curated data sets that are critical for enabling the system 102 to identify the one or more malicious domains, enforce security rules, and facilitate seamless dual-stack traffic processing.

Numerous advantages of the present disclosure may be apparent from the discussion above. In accordance with the present disclosure, the system for providing the cybersecurity services in the dual-stack traffic processing within the one or more communication networks. The system provides seamless integration of the IPV4 and IPv6 communication networks, allowing for smooth communication and data transfer between the one or more communication devices using both addressing schemes. The system eliminates the protocol incompatibility issues and enables efficient interoperability between the two protocols. With the increasing number of the one or more communication devices connecting to the one or more communication networks, the system offers efficient address management capabilities. It optimizes address allocation and ensures the effective utilization of the IPv4 addresses and the IPV6 addresses, mitigating address space exhaustion and promoting scalable network growth.

The system employs advanced routing techniques and traffic processing mechanisms, leading to enhanced network performance. It minimizes network fragmentation and avoids unnecessary translation mechanisms, resulting in improved routing efficiency, reduced latency, and optimized overall network responsiveness. By supporting dual-stack traffic processing, the system enhances network scalability. The system allows for the gradual migration from IPv4 addresses to IPV6 addresses, ensuring backward compatibility with legacy systems while enabling the adoption of newer addressing schemes. This scalability facilitates the smooth expansion of the one or more communication networks to accommodate the growing number of connected one or more communication devices.

The system incorporates robust security measures to protect the one or more communication networks such as mobile data and ensure secure communication over the communication network. It addresses potential vulnerabilities associated with protocol transitions and provides mechanisms for authentication, encryption, and secure data transmission, safeguarding against unauthorized access and data breaches. The system offers simplified and streamlined processes for transitioning from the IPV4 addresses to the IPV6 addresses. It provides tools and mechanisms to facilitate migration, reducing complexities and minimizing disruptions. This simplification eases the burden on network operators and service providers, making the transition more manageable and cost-effective. By embracing IPv6 and enabling dual-stack traffic processing, the system ensures a future-proof network architecture. It anticipates the increasing adoption of IPV6 and prepares the network for the evolving demands of emerging technologies and services, providing a solid foundation for future advancements.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A computer-implemented system for providing cybersecurity services in dual-stack traffic processing within one or more communication networks, comprising:
one or more carrier edge nodes configured to transmit traffic data packets between one or more communication devices and one or more network services within the one or more communication networks, wherein each carrier edge node of the one or more carrier edge nodes comprises:
one or more hardware processors;
a memory unit operatively connected to the one or more hardware processors, wherein the memory unit comprises a set of computer-readable instructions in form of a plurality of subsystems, configured to be executed by the one or more hardware processors, wherein the plurality of subsystems comprises:
a tagging subsystem configured to assign one or more virtual local area network (VLAN) tags to at least one of: outbound communication device-originated data, and inbound communication device-originated data for identifying the traffic data packets to enforce one or more security rules;
a prefix detection subsystem configured to:
translate Internet Protocol version 6 (IPv6) addresses associated with the outbound communication device-originated data to Internet Protocol version 4 (IPv4) addresses using one or more network address translation 64 (NAT64) prefixes; and
query one or more domain name system (DNS) servers to translate the Internet Protocol version 6 (IPv6) addresses by deriving an associated network address translation 64 (NAT64) prefix within the one or more network address translation 64 (NAT64) prefixes for authorized communication with the Internet Protocol version 4 (IPv4) destinations associated with the one or more network services;
a traffic segmentation subsystem configured to segment at least one of: the outbound communication device-originated data, and the inbound communication device-originated data into one or more categories based on one or more predefined parameters; and
a security policy enforcement subsystem configured to:
dynamically enforce the one or more security policies on the segmented at least one of: the outbound communication device-originated data, and the inbound communication device-originated data based on at least one of: the one or more virtual local area network (VLAN) tags and the one or more predefined parameters; and
detect one or more malicious domains based on the one or more security policies in the traffic data packets for providing the cybersecurity services in the dual-stack traffic processing within the one or more communication networks.

2. The computer-implemented system of claim 1, wherein each carrier edge node of the one or more carrier edge nodes is further configured to:
transmit the traffic data packets to the Internet Protocol version 4 (IPv4) destinations through the one or more carrier edge nodes, while bypassing the Internet Protocol version 6 (IPv6) addresses at each carrier edge node of the one or more carrier edge nodes until complete Internet Protocol version 6 (IPv6) security policies are enforced; and
provide customer-side translator (CLAT) functionality for the outbound communication device-originated data with only the Internet Protocol version 6 (IPv6) addresses, using a derived network address translation 64 (NAT64) prefix within the one or more network address translation 64 (NAT64) prefixes to synthesize the Internet Protocol version 6 (IPv6) addresses for the Internet Protocol version 4 (IPv4) destinations.

3. The computer-implemented system of claim 1, wherein the one or more virtual local area network (VLAN) tags comprise at least one of:
a first tag configured to identify the outbound communication device-originated data for initial processing at each carrier edge node of the one or more carrier edge nodes;
a second tag is assigned to the outbound communication device-originated data from each carrier edge node of the one or more carrier edge nodes after the one or more security policies are enforced for transmitting to the one or more network services;
a third tag configured to identify the inbound communication device-originated data directed to the one or more communication devices after the inbound communication device-originated data undergone processing at each carrier edge node of the one or more carrier edge nodes;
a fourth tag is assigned to the inbound communication device-originated data upon detection of the one or more malicious domains at each carrier edge node of the one or more carrier edge nodes for transmitting the traffic data packets to the one or more communication devices from the one or more network services; and
one or more additional virtual local area network (VLAN) tags are configured to assign to at least one of: the outbound communication device-originated data, and the inbound communication device-originated data based on the one or more predefined parameters.

4. The computer-implemented system of claim 1, wherein the prefix detection subsystem is further configured to automatically update the network address translation 64 (NAT64) prefixes based on real-time queries to the one or more domain name system (DNS) servers, ensuring compatibility with updated the Internet Protocol version 4 (IPv4) destinations.

5. The computer-implemented system of claim 1, wherein the one or more categories comprise at least one of: domain name system (DNS) traffic data, enterprise traffic data, internet-bound traffic data, and intercepted traffic data.

6. The computer-implemented system of claim 1, wherein each carrier edge node of the one or more carrier edge nodes is further configured to:
route the domain name system (DNS) traffic data through the one or more domain name system (DNS) servers configured with user-defined domain name system (DNS) policies to the one or more communication devices using the translated Internet Protocol version 6 (IPv6) addresses for communication with the one or more domain name system (DNS) servers for communicating with the Internet Protocol version 4 (IPv4) addresses;
perform reputation checks for both the Internet Protocol version 4 (IPv4) addresses and the Internet Protocol version 6 (IPv6) addresses associated with the domain name system (DNS) traffic data;

7. The computer-implemented system of claim 1, wherein each carrier edge node of the one or more carrier edge nodes is configured to process the enterprise traffic data to:
convert the Internet Protocol version 6 (IPv6) addresses to the Internet Protocol version 4 (IPv4) addresses prior to encryption, for secure communication with the Internet Protocol version 4 (IPv4) addresses associated with the one or more network services;
apply a network address translation (NAT) using Small-Medium Business (SMB)-specific Virtual Internet Protocol (VIPs) addresses;
route the enterprise traffic data through one or more secure tunnels according to the user-defined domain name system (DNS) instructions; and
decrypt and transmit the enterprise traffic data to the one or more communication devices using a designated virtual local area network (VLAN) tag within the one or more virtual local area network (VLAN) tags for managing the segmented at least one of: the outbound communication device-originated data, and the inbound communication device-originated data.

8. The computer-implemented system of claim 1, wherein the tagging subsystem is further configured to:
assign the second tag for outbound internet-bound traffic data within the internet-bound traffic data for external transmission; and
assign the fourth tag for inbound internet-bound traffic data within the internet-bound traffic data after decrypted for transmitting the traffic data packets to the one or more communication devices from the one or more network services.

9. The computer-implemented system of claim 1, wherein the traffic segmentation subsystem is configured with a secure sockets layer (SSL) interception module,
the secure sockets layer (SSL) interception module is configured to manage the intercepted traffic data through an Internet Protocol version 6 (IPv6)-capable secure sockets layer (SSL) proxy for generating outbound intercepted traffic data after the detection of one or more malicious domains for transmitting to the one or more communication devices.

10. The computer-implemented system of claim 1, wherein the one or more predefined parameters comprise at least one of: a type of application, one or more user roles, one or more traffic characteristics, destination Internet Protocol (IP) address, security requirements, network conditions, and real-time threat intelligence.

11. The computer-implemented system of claim 1, wherein the one or more security policies comprise at least one of: firewall policies, intrusion detection and prevention policies, reputation-based filtering policies, access control policies, data encryption policies, malicious domain detection policies, content filtering policies, application-specific policies, bandwidth management policies, and compliance policies.

12. The computer-implemented system of claim 1, wherein the plurality of subsystems comprises a virtual private network (VPN) management subsystem,
the virtual private network (VPN) management subsystem is configured to encapsulate the Internet Protocol version 4 (IPv4) addresses within the Internet Protocol version 6 (IPv6) addresses for providing a virtual private network (VPN) communication over an Internet Protocol version 6 (IPv6)-only network environment,
the virtual private network (VPN) management subsystem is configured to generate one or more virtual private network (VPN) tunnels using the Internet Protocol version 6 (IPv6) addresses for transmitting the traffic data packets while communicating with the Internet Protocol version 4 (IPv4) addresses.

13. A computer-implemented method for providing cybersecurity services in dual-stack traffic processing within one or more communication networks, comprising:
transmitting, by one or more carrier edge nodes, traffic data packets between one or more communication devices and one or more network services within the one or more communication networks;
assigning, by the one or more hardware processors through a tagging subsystem, one or more virtual local area network (VLAN) tags to at least one of: outbound communication device-originated data, and inbound communication device-originated data to identify the traffic data packets to enforce one or more security policies;
translating, by the one or more hardware processors through a prefix detection subsystem, Internet Protocol version 6 (IPv6) addresses associated with the outbound communication device-originated data to Internet Protocol version 4 (IPv4) addresses using one or more network address translation 64 (NAT64) prefixes;
querying, by the one or more hardware processors through the prefix detection subsystem, one or more domain name system (DNS) servers to translate the Internet Protocol version 6 (IPv6) addresses by deriving an associated network address translation 64 (NAT64) prefix within the one or more network address translation 64 (NAT64) prefixes for authorized communication with Internet Protocol version 4 (IPv4) destinations associated with the one or more network services;
segmenting, by the one or more hardware processors through a traffic segmentation subsystem, at least one of: the outbound communication device-originated data, and the inbound communication device-originated data into one or more categories based on one or more predefined parameters;
enforcing, by the one or more hardware processors through a security policy enforcement subsystem, the one or more security policies on the segmented at least one of: the outbound communication device-originated data, and the inbound communication device-originated data based on at least one of: the one or more virtual local area network (VLAN) tags and the one or more predefined parameters; and
detecting, by the one or more hardware processors through the security policy enforcement subsystem, one or more malicious domains based on the one or more security policies in the traffic data packets for providing the cybersecurity services in the dual-stack traffic processing within the one or more communication networks.

14. The computer-implemented method of claim 13, further comprises:
transmitting, by each carrier edge node of the one or more carrier edge nodes, the traffic data packets to the Internet Protocol version 4 (IPv4) destinations through the one or more carrier edge nodes, while bypassing the Internet Protocol version 6 (IPv6) addresses at each carrier edge node of the one or more carrier edge nodes until complete Internet Protocol version 6 (IPv6) security policies are enforced; and
providing, by each carrier edge node of the one or more carrier edge nodes, Customer-side translator (CLAT) functionality for the outbound communication device-originated data with only the Internet Protocol version 6 (IPv6) addresses, using a derived network address translation 64 (NAT64) prefix within the one or more network address translation 64 (NAT64) prefixes to synthesize the Internet Protocol version 6 (IPv6) addresses for the Internet Protocol version 4 (IPv4) destinations.

15. The computer-implemented method of claim 13, wherein the one or more virtual local area network (VLAN) tags comprise at least one of:
a first tag configured to identify the outbound communication device-originated data for initial processing at each carrier edge node of the one or more carrier edge nodes;
a second tag is assigned to the outbound communication device-originated data from each carrier edge node of the one or more carrier edge nodes after the one or more security policies are enforced for transmitting to the one or more network services;
a third tag configured to identify the inbound communication device-originated data directed to the one or more communication devices after the inbound communication device-originated data undergone processing at each carrier edge node of the one or more carrier edge nodes;
a fourth tag is assigned to the inbound communication device-originated data upon detection of the one or more malicious domains at each carrier edge node of the one or more carrier edge nodes for transmitting the traffic data packets to the one or more communication devices from the one or more network services; and
one or more additional virtual local area network (VLAN) tags are configured to assign to at least one of: outbound communication device-originated data, and inbound communication device-originated data based on the one or more predefined parameters.

16. The computer-implemented method of claim 13, wherein the one or more categories comprise at least one of: domain name system (DNS) traffic data, enterprise traffic data, internet-bound traffic data, and intercepted traffic data.

17. The computer-implemented method of claim 13, wherein the one or more predefined parameters comprise at least one of: a type of application, one or more user roles, one or more traffic characteristics, destination Internet Protocol (IP) address, security requirements, network conditions, and real-time threat intelligence.

18. The computer-implemented method of claim 13, wherein the one or more security policies comprise at least one of: firewall policies, intrusion detection and prevention policies, reputation-based filtering policies, access control policies, data encryption policies, malicious domain detection policies, content filtering policies, application-specific policies, bandwidth management policies, and compliance policies.

19. The computer-implemented method of claim 13, further comprising:
encapsulating, by the one or more hardware processors through a virtual private network (VPN) management subsystem, the Internet Protocol version 4 (IPv4) addresses within the Internet Protocol version 6 (IPv6) addresses to provide a virtual private network (VPN) communication over an Internet Protocol version 6 (IPv6)-only network environment; and
generating, by the one or more hardware processors through the virtual private network (VPN) management subsystem, one or more virtual private network (VPN) tunnels using the Internet Protocol version 6 (IPv6) addresses for transmitting the traffic data packets while communicating with the Internet Protocol version 4 (IPv4) addresses.

20. A non-transitory computer-readable storage medium storing computer-executable instructions that, when executed by one or more hardware processors, cause the one or more hardware processors to perform operations for providing cybersecurity services in dual-stack traffic processing within one or more communication networks, the operations comprising:
transmitting traffic data packets between one or more communication devices and one or more network services within the one or more communication networks;
assigning one or more virtual local area network (VLAN) tags to at least one of: outbound communication device-originated data, and inbound communication device-originated data to identify the traffic data packets to enforce one or more security policies;
translating Internet Protocol version 6 (IPv6) addresses associated with the outbound communication device-originated data to Internet Protocol version 4 (IPv4) addresses using one or more network address translation 64 (NAT64) prefixes;
querying one or more domain name system (DNS) servers to translate Internet Protocol version 6 (IPv6) addresses by deriving an associated network address translation 64 (NAT64) prefix within the one or more network address translation 64 (NAT64) prefixes for authorized communication with Internet Protocol version 4 (IPv4) destinations associated with the one or more network services;
segmenting at least one of: the outbound communication device-originated data, and the inbound communication device-originated data into one or more categories based on one or more predefined parameters;
enforcing the one or more security policies on the segmented at least one of: the outbound communication device-originated data, and the inbound communication device-originated data based on at least one of: the one or more virtual local area network (VLAN) tags and the one or more predefined parameters; and
detecting one or more malicious domains based on the one or more security policies in the traffic data packets for providing the cybersecurity services in the dual-stack traffic processing within the one or more communication networks.
